(19) United States
(12) Patent Application Publication
(10) Pub. No.: US 2005/0162417 A1
(43) Pub. Date: Jul. 28, 2005

(54) Image processing method and apparatus

(75) Inventors: Yasunori Taguchi, Kanagawa (JP); Yasuhiro Yanaka, Kanagawa (JP); Takashi Ida, Kanagawa (JP); Yoshihiro Ohmori, Kanagawa (JP); Nobuyuki Matsumoto, Kanagawa (JP); Hidenori Takeshima, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/019,377

(22) Filed: Dec. 23, 2004

(30) Foreign Application Priority Data
Dec. 26, 2003 (JP) 2003-435817

(51) Int. Cl. G03B 17/00

(52) U.S. Cl. 345/418

(57) ABSTRACT

In a preferred embodiment, an image-combining apparatus 212 includes a photographing unit 201, a composition unit 202, an input unit 204, a creation unit 206, an adjustment end instruction unit 208, and a display 211. An image of an object is photographed at S1010; a previously determined information-provision graphic is created at S1020; the information-provision graphic is combined with the photographed image at S1030, and is displayed on a display 211. On a preliminary composite image, the foot position of the object may be higher than the foot position of the information-provision graphic, or the information-provision graphic and the image of the object may not fit each other in size, or the object may be inclined. Then, position or the like of the object on the image may be adjusted.

### CROSS-REFERENCE TO RELATED APPLICATIONS

This application is based upon and claims the benefit of priority from the prior Japanese Patent Application No. 2003-435817, filed on Dec. 26, 2003; the entire contents of which are incorporated herein by reference.

### TECHNICAL FIELD

The present invention relates to an image processing method for combining images photographed at plural points.

### BACKGROUND OF THE INVENTION

There is known an image processing method for combining and displaying images in which objects existing at plural points are photographed (Osamu MORIKAWA, “Hyper Mirror: Pleasant-to-use Video Mediated Communication System”, Journal of Information Processing Society of Japan, vol. 41-3, pp. 815-822, 2000). In this image processing method, for example, in the case where images photographed at two separate points are combined with other, an area of an object is extracted from, for example, an image of FIG. 41 photographed at one of the points, and is superimposed on, for example, an image of FIG. 42 photographed at the other of the points and is combined therewith.

In order to extract the area of the object from the image, a technique called a background difference method is used. In the background difference method, extraction of the area of the object become difficult in following occasions: an illumination change occurs; correction of a camera is performed; things photographed behind the object are vibrated (for example, in the case where leaves are swayed), or the like.

In order to extract the area of an object with high accuracy even in the case where the illumination change occurs or the correction of the camera is performed, a normalized distance disclosed in, for example, following document is conventionally used: Shigeki Nagaya, Takafumi Miyatake, Takehiro Fujita, Wataru Itoh, Hirotada Ueda, “Moving Object Detection by Time Correlation Background Judgment Method”, Journal of Institute of Electronics, Information and Communication Engineers, D-II, Vol. J79-D-II, No. 4, pp. 568-576, 1994. It is known that when the normalized distance is used, an image is partitioned into blocks, and in the case where pixel values of pixels in each of the blocks are linearly changed; the area of the object is extracted with high accuracy in block units.

Besides, in order that the object is extracted with high accuracy even in the case where things photographed behind the object are vibrated, a technique of, for example, JP-A-8(1996)-44874 is conventionally used. In this technique, from a time series of images in which an object is not photographed, posterior probability calculated from a histogram of feature quantities of respective areas of the image is used to extract the area of the object. It is known that when an image in which an object is not photographed exists for a long time, the area of the object is extracted with high accuracy.

In this way, by the conventional technique, for example, a composite image as shown in FIG. 43 is displayed in which objects existing at different points in the actual world exist in the same world, and the difference between the world of the composite image and the actual world is enjoyed.

However, in the conventional technique, there is a problem that until the composite image desired by the user is displayed, the user must take labor and time to adjust photograph conditions while watching the composite image. For example, an image as shown in FIG. 44 in which the heights of foot positions of the objects existing at plural points are out of alignment with each other in the composite image, is usually undesirable.

Besides, there is a problem that accuracy at which the area of the object is extracted from the image is low, and the quality of the composite image is not sufficient. For example, there is a problem that in the case where pixel values of pixels are changed nonlinearly by the illumination change or the correction of a camera, the area of the object is not extracted with high accuracy, and there is a problem that in the case where an image in which an object is not photographed exists only for a short time, the area of the object is not extracted with high accuracy.

Further, there is a problem that after the images are combined and displayed, since the display is abruptly changed to a photographed image or a specified image, the user feels emptiness.

Then, the present invention provides an invention which facilitates adjustment of photograph conditions, can extract an area of an object with high accuracy, and prevents a user from immediately feeling emptiness.

### BRIEF SUMMARY OF THE INVENTION

According to embodiments of the present invention, in an image processing method for combining a own image in which an object is photographed with another image, the own image is inputted, an information-provision graphic for determination of a reference position at a time when an area of the object of the own image and an area of an object of the another image are combined with each other is created, the object in the own image is positioned relative to a position of the information-provision graphic as the reference position, and the positioned image is displayed on a display unit.

According to the embodiments, the respective objects are combined with each other relative to the information-provision graphic and can be displayed.

### BRIEF DESCRIPTION OF THE DRAWINGS

FIG. 1 is a flowchart showing a flow of a processing in a first embodiment.

FIG. 2 is an explanatory view showing a schematic structure of an image-combining apparatus according to the first embodiment.

FIG. 3 is an explanatory view showing a structure of a composition unit 203.

FIG. 4 is an explanatory view showing a structure of an input image composition unit 304.

FIG. 5 is an explanatory view showing an example in which image-combining apparatuses according to the first embodiment are directly connected to each other.

FIG. 6 is an explanatory view showing an image of an object photographed before photograph conditions are adjusted.

FIG. 7 is an explanatory view showing a previously determined information-provision graphic.

FIG. 8 is an explanatory view showing a composite image of the photographed image of FIG. 6 and the information-provision graphic of FIG. 7.

FIG. 9 is an explanatory view showing a composite image of an image of an object photographed after the photograph conditions are adjusted and the information-provision graphic of FIG. 7.

FIG. 10 is an explanatory view showing an example in which image-combining apparatuses according to the first embodiment are connected to each other through a network.

FIG. 11 is a flowchart in which a step of adjustment by a user adjustment instruction is inserted in the flowchart of FIG. 1.

FIG. 12 is an explanatory view showing a schematic structure in which an adjustment instruction unit 216 is added to the image-combining apparatus of FIG. 2 according to the first embodiment.

FIG. 13 is an explanatory view showing an example of an information-provision graphic by which adjustment of a shutter speed becomes easy.

FIG. 14 is an explanatory view showing an information-provision graphic which can be selected by a partner side and which is limited to a case where a user desires to combine images so that an object at a user side becomes larger than an object at a partner side.

FIG. 15 is an explanatory view showing a composite image in which one object is larger than the other object.

FIG. 16 is an explanatory view showing a sample of a composite image of a large person and a small person.

FIG. 17 is an explanatory view showing a sample of a composite image of a fat person and a thin person.

FIG. 18 is an explanatory view showing a sample of a composite image of a rotated person and a not-rotated person.

FIG. 19 is an explanatory view showing a sample of a composite image of a person with a duplicate and a person without a duplicate.

FIG. 20 is an explanatory view showing a schematic structure of an image-combining apparatus according to a second embodiment.

FIG. 21 is a flowchart showing a flow of a processing in the second embodiment.

FIG. 22 is an explanatory view showing a schematic structure of an image-combining apparatus in which a storage instruction unit 2202 is added to the image-combining apparatus according to the second embodiment of FIG. 20.

FIG. 23 is a flowchart showing a flow of a processing in a third embodiment.

FIG. 24 is a view for explaining respective processes in the third embodiment.

FIG. 25 is an explanatory view showing a calculated pixel value mapping.

FIG. 26 is an explanatory view showing an example in which pixel values of respective pixels of a reference image are object to the pixel value mapping.

FIG. 27 is an explanatory view showing a failure example of estimation of a background area.

FIG. 28 is an explanatory view showing a successful example of estimation of a background area.

FIG. 29 is a flowchart showing a flow of a processing in a fourth embodiment.

FIG. 30 is an explanatory view showing a time series of pixel values of a pixel in a still state.

FIG. 31 is an explanatory view showing a time series of pixel values of a pixel in a steady change state.

FIG. 32 is an explanatory view showing an example of a histogram created in a certain pixel in a still state.

FIG. 33 is an explanatory view showing an example of a histogram created in a pixel in a steady change state.

FIG. 34 is an explanatory view showing an example of a noted pixel and its surrounding pixels.

FIG. 35 is a flowchart showing a processing procedure in a case where the fourth embodiment is applied to the creation of an estimated object area 404 in the first embodiment.

FIG. 36 is an explanatory view showing an example of a frame image of a reference image 402.

FIG. 37 is an explanatory view showing an example of a photographed image 202 which is shifted from FIG. 36 by hands movement and in which positions of leaves are shifted by the sway of the leaves.

FIG. 38 is an explanatory view showing an example in which an object and an area not the object are judged from FIG. 37 according to the third embodiment.

FIG. 39 is an explanatory view showing an example of a normal distribution.

FIG. 40 is an explanatory view showing an image in which FIG. 41 is reduced.

FIG. 41 is an explanatory view showing an example of an image photographed at one point.

FIG. 42 is an explanatory view showing an example of an image photographed at the other point.

FIG. 43 is an explanatory view showing an example of a composite image.

FIG. 44 is an explanatory view showing an example of an image in which the heights of foot positions of the objects existing at plural points are out of alignment with each other in the composite image.

### DETAILED DESCRIPTION OF THE INVENTION

### First Embodiment

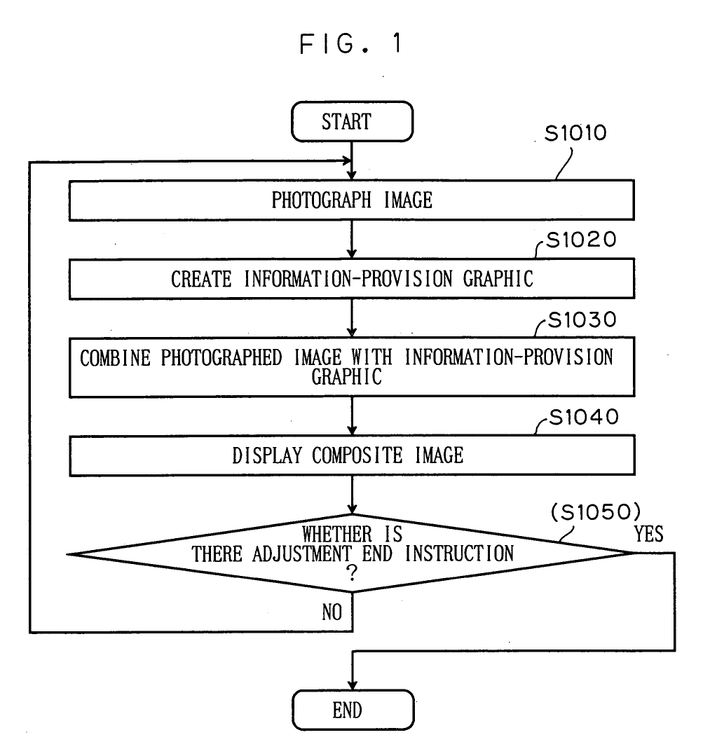

An image processing apparatus of a first embodiment of the invention relates to an image-combining apparatus 212 which performs image composition as one of image processings, is one in which a photographed image is combined with an information-provision graphic and is displayed, and will be described with reference to FIGS. 1 to 9.

Incidentally, it is assumed that each pixel of an image has a pixel value. The “pixel value” is a vector corresponding to a pixel and having actual values as elements. The vector may be a one-dimensional vector, that is, a scalar. In a grayscale image, integer values of 0 to 255 are often used as the pixel values. There is also a case where integer values of 0 and 1 are used. In the following description, in the case where the pixel value is a one-dimensional vector, that is, a scalar, the pixel value is called a “density value”. In a color image, a tree-dimensional vector composed of a pair of integer values of 0 to 255 is often used as the pixel value.

The respective elements of a vector are often used in such a manner that values of an RGB color system are fitted to integer values of 0 to 255. In addition to that, a Munsell color system, an XYZ color system, or another color system is used. Several of such color systems are introduced in Chapter 5 of “Image Analysis Handbook”, ed. by Mikio TAKAGI and Haruhisa SHIMODA, University of Tokyo Press, 1st edition, Jan. 17, 1991, ISBN 4-13-061107-0 C3050 P25750E. The definition of a distance is given in 8.1 of Chapter 8 in following book: LIPSCHUTZ, “General Topology”, The McGraw-Hill Companies (translated to Japanese by Tatemasa OYA, Masazumi HANAZAWA, first edition published on Jun. 25, 1987, second edition published on Mar. 20, 1993, ISBN4-89501-539-4 C3041 P2400E). For example, one of distances between a density value “a” and a density value “b” is an absolute value of (a−b).

An image-combining apparatus 212 is constructed of a photographing unit 201, a composition unit 202, an input unit 204, a creation unit 206, an adjustment end instruction unit 208, and a display 211.

(1) Processing Procedure of the Image-Combining Apparatus 212

FIG. 1 is a flowchart showing a flow of a processing of the image-combining apparatus 212. The flow of the processing will be described with reference to FIG. 1.

First, at S1010, an image of an object, for example, as shown in FIG. 6 is photographed.

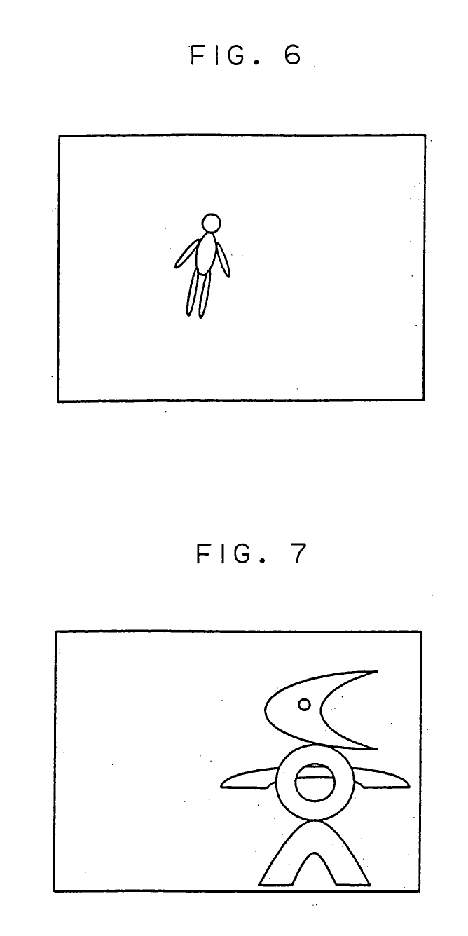

Next, at S1020, a previously determined information-provision graphic, for example, as shown in FIG. 7 is created. In the information-provision graphic of S1020, the same image may be created every time (that is, a still image is created), or a different image may be created every time (that is, a moving image is created). In the case where the moving image is created, for example, a frame number is separately recorded, and at the process of S1020, an image corresponding to the frame number is created, and each time the process of S1020 is performed, the frame number has only to be added.

Next, at S1030, the image photographed at S1010 is combined with the information-provision graphic created at S1020, and is displayed on the display 211. For example, a composite image as shown in FIG. 8 is displayed.

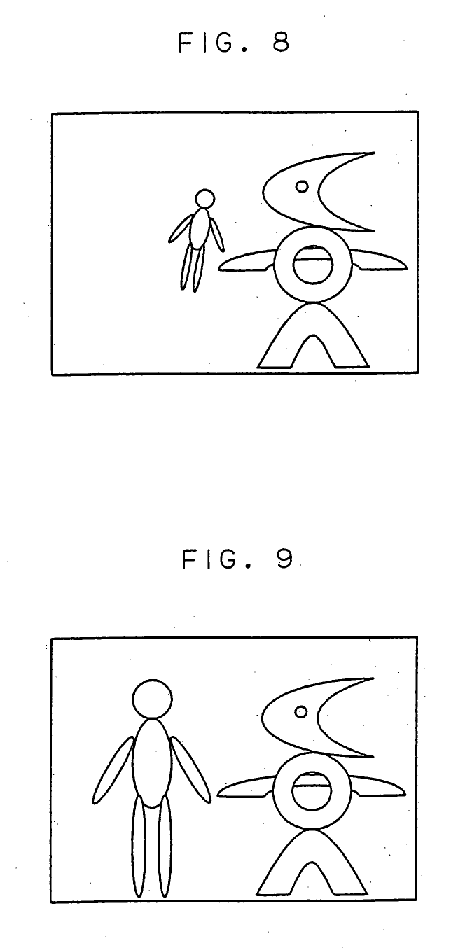

Next, at S1040, the image combined at S1030 is displayed. In the case where FIG. 8 is displayed at S1040, it is confirmed that the foot position of the object is higher than the foot position of the information-provision graphic, the information-provision graphic and the image of the object do not fit each other in size, and the object is inclined. On the basis of the displayed composite image, the unit used for the photographing at S1010 is moved, or the object is moved, so that photograph conditions are adjusted, and therefore, the object is positioned, and for example, a composite image of FIG. 9 is displayed.

Next, at S1050, according to instructions to end the adjustment of the photograph conditions, that is, instructions to end the positioning, a conditional branch occurs. In the case where there are no instructions, the procedure returns to S1010. In the case where there are instructions, the processing is ended.

(2) Structure of the Image-Combining Apparatus 212

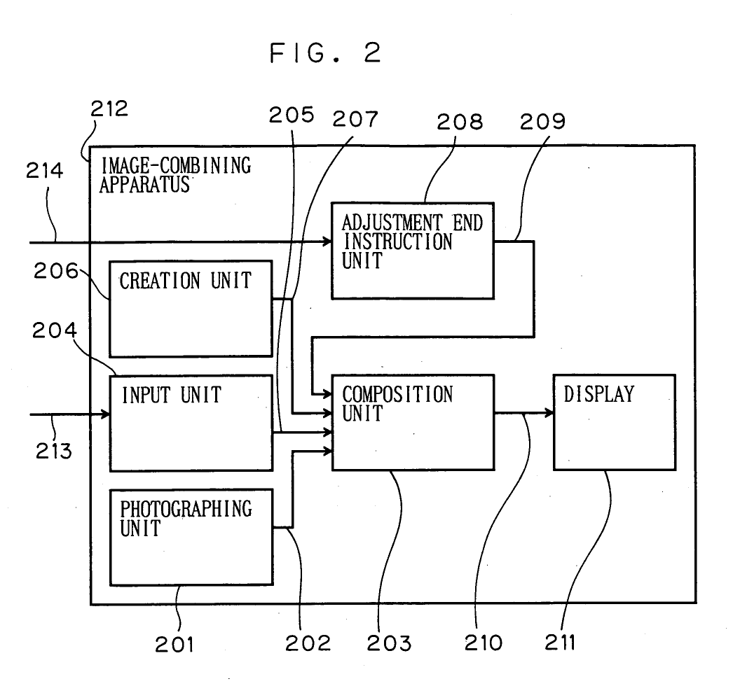

FIG. 2 is an explanatory view showing the schematic structure of the image-combining apparatus 212 according to this embodiment. The schematic structure of the image-combining apparatus 212 will be described with reference to FIG. 2.

An external image 213 is inputted from the outside of the image-combining apparatus 212 and is sent to the input unit 204. Besides, a user operates the adjustment end instruction unit 208 so that an adjustment end operation 214 is performed.

In the inside of the image-combining apparatus 212, an image of an object is photographed by the photographing unit 201 and is sent as a photographed image 202 to the composition unit 203.

In the input unit 204, the external image 213 is sent as an input image 205 to the composition unit 203.

In the creation unit 206, an image, for example, as shown in FIG. 7 is created, which specifies the height of foot position of the object of the photographed image 202, and is sent as an information-provision graphic 207 to the composition unit 203.

In the adjustment end instruction unit 208, whether or not the adjustment of the photograph conditions is ended by an adjustment end operation 214 is sent as an adjustment end instruction 209 to the composition unit 203.

The composition unit 203 has a structure as shown in FIG. 3, outputs a composite image 210 and sends it to the display 211. The composition unit 203 will be described later with reference to FIG. 3.

The composite image 210 is displayed on the display 211.

The photographing unit 201 is, for example, a CCD camera or a CMOS camera which can output electronic signals of an image The composition unit 203, the input unit 204 and the creation unit 206 are, for example, a combination of an electronic circuit, a ROM and a RAM. The adjustment end instruction unit 208 is, for example, an exclusive switch, and the display 211 is, for example, a projector and its projection surface, a television, or a display.

(2-1) Structure of the Composition Unit 203

The structure of the composition unit 203 will be described with reference to FIG. 3.

The photographed image 202, the input image 205, the information-provision graphic 207, and the adjustment end instruction 209 are inputted to the composition unit 203. That is, the photographed image 202 is inputted to an information-provision graphic composition unit 301 and an input image composition unit 304. The input image 205 is inputted to the input image composition unit 304. The information-provision graphic 207 is inputted to the information-provision graphic composition unit 301. The adjustment end instruction 209 is inputted to a selection unit 303 and the input image composition unit 304.

In the information-provision graphic composition unit 301, the information-provision graphic 207 is superimposed on the photographed image 202 and is combined therewith, and is sent as an information provision composite image 302 to the selection unit 303.

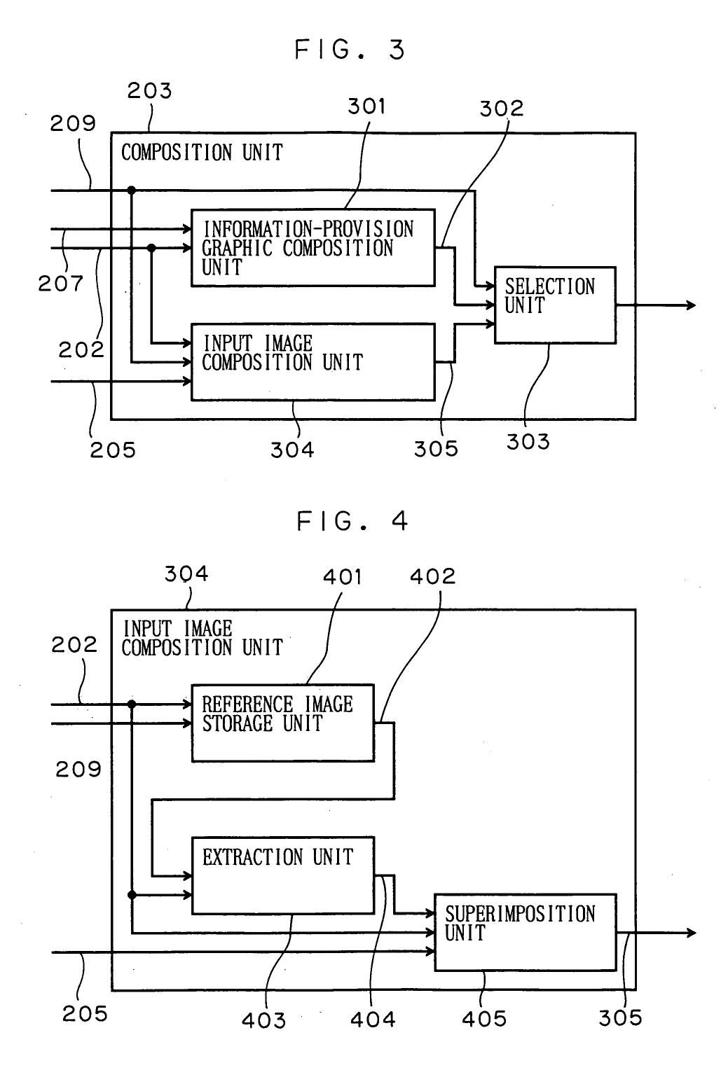

The input image composition unit 304 has a structure as shown in FIG. 4, outputs an input composite image 305 and sends it to the selection unit 303. The input image composition unit 304 will be described later with reference to FIG. 4.

In the selection unit 303, in the case where the adjustment end instruction 209 does not indicate the adjustment end of the photograph conditions (that is, the end of positioning), the information provision composite image 302 is selected as the composite image 210 and is outputted. In the case where the adjustment end instruction 209 indicates the adjustment end of the photograph conditions (that is, the end of positioning), the input composite image 305 is selected as the composite image 210 and is outputted.

(2-2) Structure of the Input Image Composition Unit 304

The structure of the input image composition unit 304 will be described with reference to FIG. 4.

The photographed image 202, the input image 205, and the adjustment end instruction 209 are inputted to the input image composition unit 304. That is, the photographed image 202 is inputted to a reference image storage unit 401, an extraction unit 403, and a superimposition unit 405. The input image 205 is inputted to the superimposition unit 405. The adjustment end instruction unit 209 is inputted to the reference image storage unit 401.

In the reference image storage unit 401, the photographed image 202 is stored until a specified time has passed since the adjustment end instruction 209 indicated the adjustment end, and after the specified time has passed, the stored image is sent as a reference image 402 to the extraction unit 403.

In the extraction unit 403, when the reference image 402 is not sent, anything is not done, and when the reference image 402 is sent, a set of pixels in which a difference in a pixel value of each pixel between the photographed image 202 and the averaged image of the reference image 402 is larger than a specified threshold is sent as an estimated object area 404 to the superimposition unit 405. Incidentally, for the purpose of creating the estimated object area 404, a third embodiment or a fourth embodiment described later may be used.

In the superimposition unit 405, when the estimated object area 404 has not been sent, the photographed image 202 is outputted as the input composite image 305, and when the estimated object area 404 has been sent, an image is created in which the photographed image 202 is embedded in the pixels indicated by the estimated object area 404, and the input image 205 is embedded is the remaining pixels, and is outputted as the input composite image 305. The input composite image 305 at the time when the estimated object area 404 has been sent becomes an image in which the area of the object of the photographed image 202 is superimposed on the input image 205.

(3) Connection Example of the Image-Combining Apparatus 212

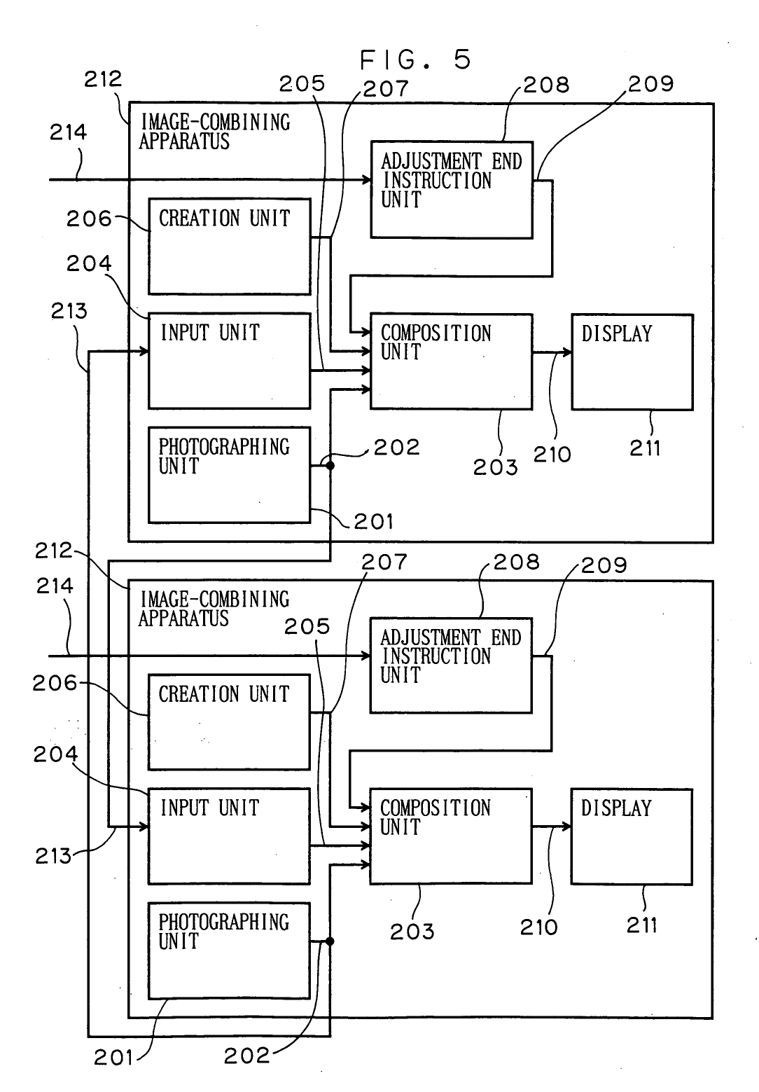

FIG. 5 shows an example of connection in which the photographed image 202 is outputted from the image-combining apparatus 212 of FIG. 2.

The photographed image 202 outputted from the photographing unit 201 of the upper image-combining apparatus 212 is inputted as the external image 213 to the input unit 204 of the lower image-combining apparatus 212. Besides, the photographed image 202 outputted from the photographing unit 201 of the lower image-combining apparatus 212 is inputted as the external image 213 to the input unit 204 of the upper image-combining apparatus 212.

(4) Effects of the First Embodiment

According to the first embodiment, the user can easily adjust the photograph conditions while watching the composite image of the photographed image and the information-provision graphic. Besides, since the user does not adjust the photograph conditions while watching the composite image of the photographed image and the input image, the adjustment of the photograph conditions can be performed before the input image is inputted.

### MODIFIED EXAMPLES OF THE FIRST EMBODIMENT

Hereinafter, modified examples of the first embodiment will be described. For explanation, an origin from which the external image 213 is sent is called a “partner”.

### (1) Modified Example 1

In the first embodiment, although the process of S1020 is performed after the process of S1010 in the flow of the processing of FIG. 1, the order of the processes of S1010 and S1020 may be reversed.

Then, since the same composition as that of FIG. 1 is performed, the same effect as that of the first embodiment can be obtained.

### (2) Modified Example 2

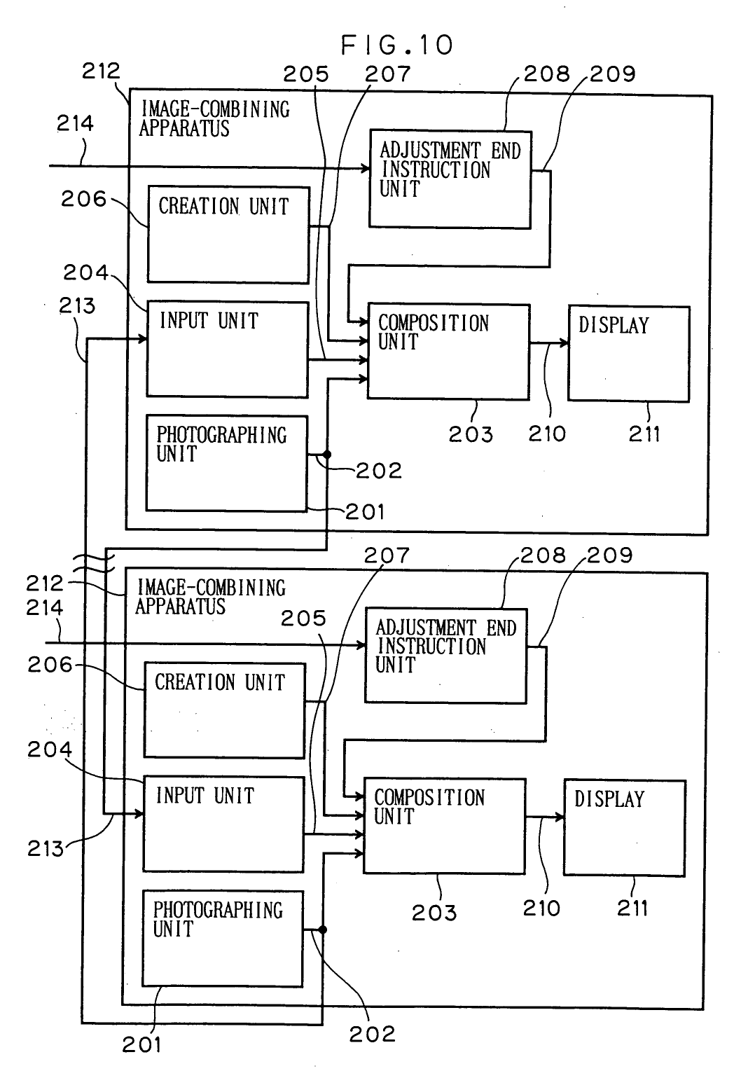

In the first embodiment, although the image-combining apparatuses 212 are directly connected to each other in the connection example of FIG. 5, they are not directly connected, but may be connected through a network as shown in FIG. 10.

In that case, an image may be combined with an unspecified partner, or an image may be combined with a partner satisfying a specific condition. By this modification, an image is combined with various partners.

### (3) Modified Example 3

In the first embodiment, although the one image-combining apparatus 212 is connected to the one image-combining apparatus 212 in the connection example of FIG. 5, two or more image-combining apparatuses 212 may be connected to the one image-combining apparatus 212.

In that case, the input unit 204 has only to be increased in the image-combining apparatus 212. When the input unit 204 is increased, the input image 205 inputted to composition unit 203 is increased. A composition method of the photographed image 202 and the input image 205 in the case where the adjustment end instruction 208 indicates that the adjustment of the photograph conditions is ended, is as follows.

First, one image is selected from the photographed image 202 and the two or more input images 205, and an area of an object is extracted from the other images. Next, the area is superimposed on the selected image and is combined therewith. A method of extracting the area of the object from the image may be the same as that of the first embodiment.

When the number of the connected image-combining apparatuses 212 is increased, the adjustment of the photograph conditions becomes more troublesome. However, since the information-provision graphic 207 is created and is displayed on the display 211, the photograph conditions are easily adjusted while the composite image of the photographed image and the information-provision graphic is watched.

### (4) Modified Example 4

In the first embodiment, although the image-combining apparatuses 212 are connected to each other in the connection example of FIG. 5, it is not always necessary to do so. Since the external image 213 has only to be inputted to the image-combining apparatus 212, the input origin of the external image 213 may be an apparatus which cannot combine images.

In the image-combining apparatus 212, the information-provision graphic 207 is created and is displayed on the display 211, and the photograph conditions are easily adjusted. By this modification, at the side of the image-combining apparatus 212, the same effect as that of the first embodiment can be obtained.

### (5) Modified Example 5

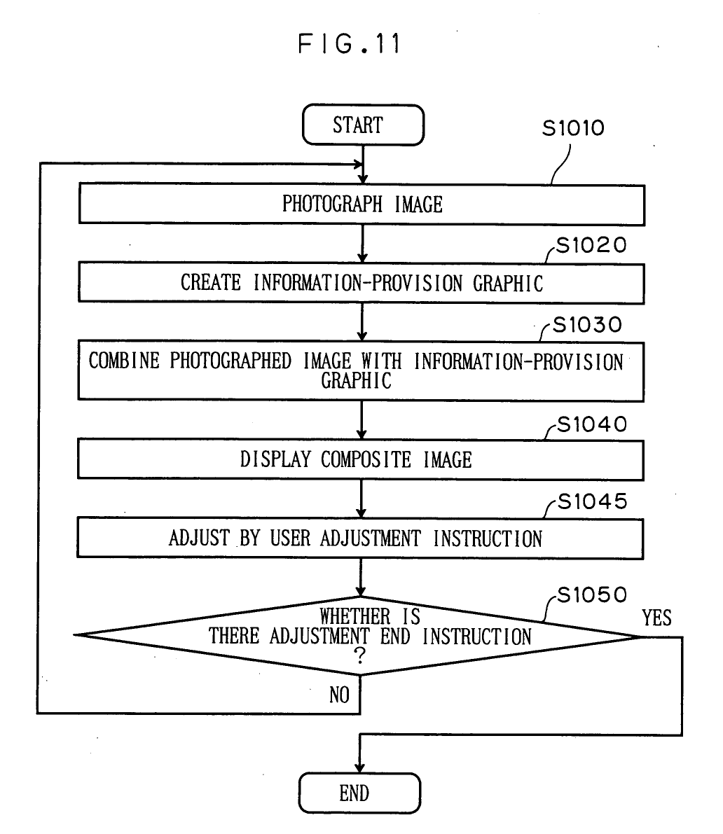

As in FIG. 11, a process of S1045 may be inserted between the processes of S1040 and S1050 of the flow of the processing of the first embodiment of FIG. 1.

At S1045, parameters for the adjustment of zoom, shutter speed, white balance and the like of the unit used for photographing at S1010 are adjusted by the instructions of the user.

Incidentally, the insertion position of the process of S1045 may be any position as long as it is prior to the process of S1050. However, only when it is inserted prior to the process of S1010, it is necessary to return to the process of S1010 in the case of NO at the conditional branch of the process of S1050.

When such modification is made, the photograph conditions are adjusted in addition to the movement of the unit used for photographing at S1010 and the movement of the object photographed at S1010, and the adjustment of the photograph conditions become easier.

### (6) Modified Example 6

In the first embodiment, although the parameters of the photographing unit 201 are not changed by the operation of the user in the image-combining apparatus 212 of FIG. 2, they may be changed.

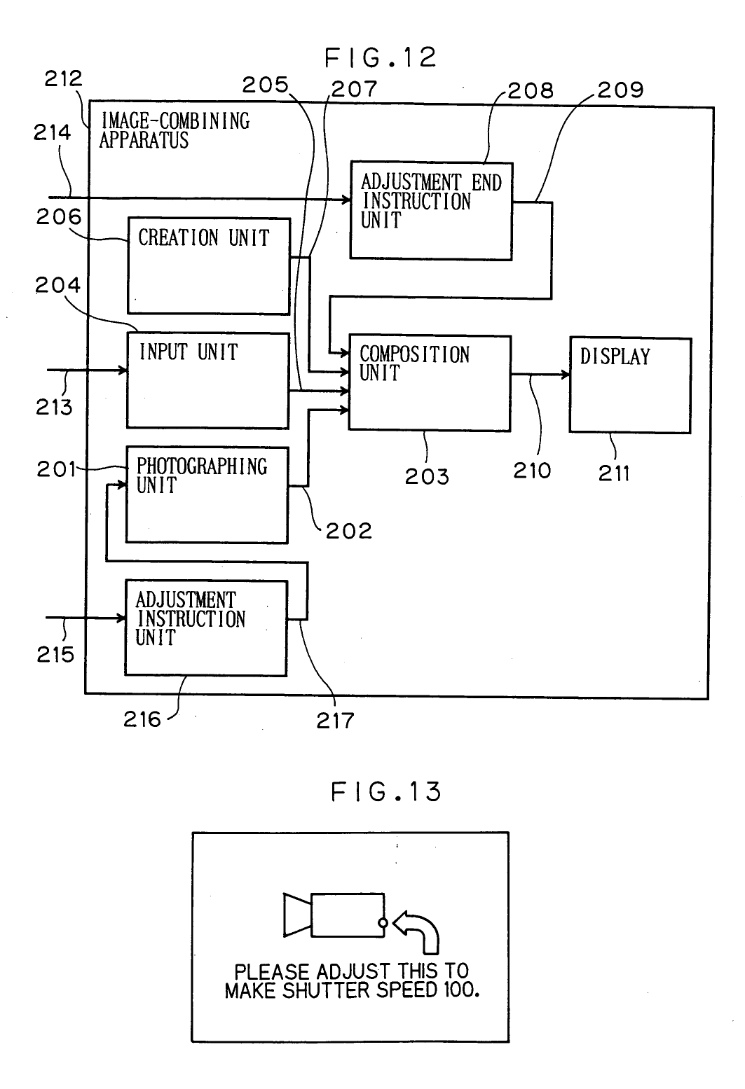

For example, as shown in FIG. 12, an adjustment instruction unit 216 may be added to FIG. 2. In the adjustment instruction unit 216, the user operates the adjustment instruction unit 216 so that a user adjustment operation 217 is performed. By the user adjustment operation 214, an instruction for the adjustment of the parameters of the photographing unit 201 is issued, and is sent as the adjustment instruction 217 to the photographing unit 201. In the photographing unit 201, the parameters of the photographing unit 201 are changed on the basis of the adjustment instruction 217.

Incidentally, the adjustment instruction unit 216 is, for example, a button, a dial or a remote control. The adjustment instruction unit 216 is used, and the parameters for adjustment of, for example, the zoom, shutter speed, white balance and the like of the photographing unit 201 are adjusted.

When the modification is made in this way, it becomes possible for the operator of the adjustment instruction unit 216 to perform the user adjustment operation 217 by the adjustment instruction unit 216 while watching the display 211, and the adjustment of the photograph conditions become easier.

When the adjustment instruction unit 216 is the remote control, the object himself/herself of the photographing unit 201 can perform the user adjustment operation 217 as the operator of the adjustment instruction unit 216, while watching the display 211 and holding the adjustment instruction unit 216.

By this modification, the adjustment of the photograph conditions becomes further easier.

### (7) Modified Example 7

In the first embodiment, although the information-provision graphic created at S1020 is previously determined in the flow of the processing of FIG. 1, it may be selected from plural candidates.

Besides, the information-provision graphic may be downloaded through a network. When the information-provision graphics capable of providing various pieces of information are downloaded, the adjustment of the photograph conditions becomes easier.

### (8) Modified Example 8

In the first embodiment, although the example is described in which the information-provision graphic of FIG. 7 is created at S1020 in the flow of the processing of FIG. 1, it is not necessary that the information-provision graphic is the figure as shown in FIG. 7.

The information-provision graphic may be another figure, a character, an animated image, a CG image, a photographed image or the like. For example, when FIG. 13 is created, the adjustment of the shutter speed becomes easy. When a photographed image or a color bar is created, the color tone or white balance is easily adjusted. By this modification, the adjustment of the photograph conditions becomes easier.

### (9) Modified Example 9

In the first embodiment, in the display of the information-provision graphic, a sound or a voice may be used for information provision.

By this modification, the adjustment of the photograph conditions becomes easier.

### (10) Modified Example 10

In the first embodiment, as is apparent from the flow of the processing of FIG. 1, although the information-provision graphic is combined and displayed only before the instruction of the end of the adjustment of the photograph conditions, it may be combined and displayed at any time.

For example, the information-provision graphic is used to issue an instruction to the user, so that the object is moved and is not photographed when the image is stored in the reference image storage unit 401 of FIG. 4.

By this modification, information can be provided to the user at any time.

### (11) Modified Example 11

Modified example 9 or modified example 10 of the first embodiment is further modified, and the appearance and disappearance of the information-provision graphic, and other operations may be determined by time, elapsed time, feature quantity calculated from an image, and the like.

By this modification, information corresponding to a state can be provided to the user.

### (12) Modified Example 12

In the first embodiment, although the photographed image 202 is directly sent to the partner in the connection example of FIG. 5, the area of the object is extracted from the photographed image 202, and only the area may be sent.

For that purpose, it is appropriate that for example, the area of the object is extracted in the composition unit 203, and the area is further outputted separately from the composite image 210 and is sent to the partner. Then, it becomes unnecessary that the photographed image 202 is sent to the partner, and communication load and delay occurring due to communication are reduced.

### (13) Modified Example 13

In modified example 7 of the first embodiment, although the information-provision graphic is selected from the plural candidates, since the synchronization of the information-provision graphic is not achieved between the user side image-combining apparatus and the partner side image-combining apparatus, it may be made possible.

As a first method of achieving the synchronization, it is appropriate to make it possible for the user side to determine the information-provision graphic of the partner side.

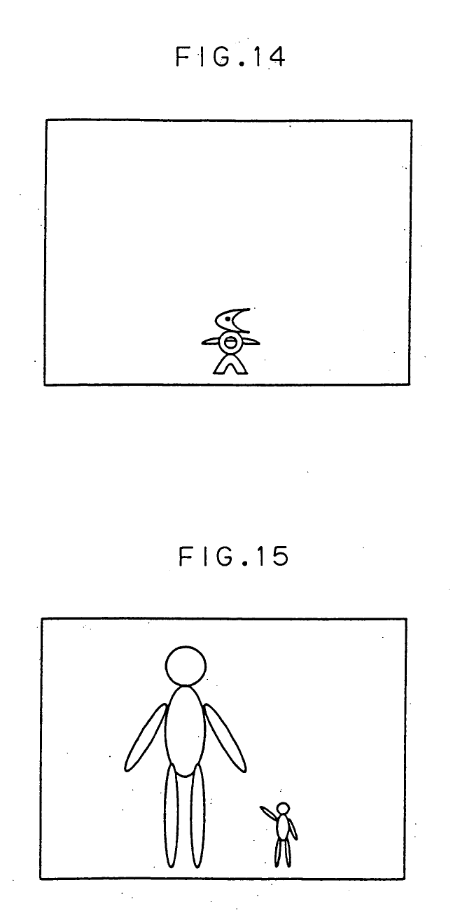

As a second method of achieving the synchronization, when the information-provision graphic is selected at the user side, the information-provision graphic which can be selected by the partner side may be limited. For example, for the case where the user desires to combine the images so that the object at the user side becomes larger than the object at the partner side, when the information-provision graphic of FIG. 7 is selected at the user side, the partner side is confined so that only the information-provision graphic of FIG. 14 can be selected. When the photograph conditions are adjusted on the basis of the information-provision graphics at the user side and the partner side, a composite image of FIG. 15 is obtained.

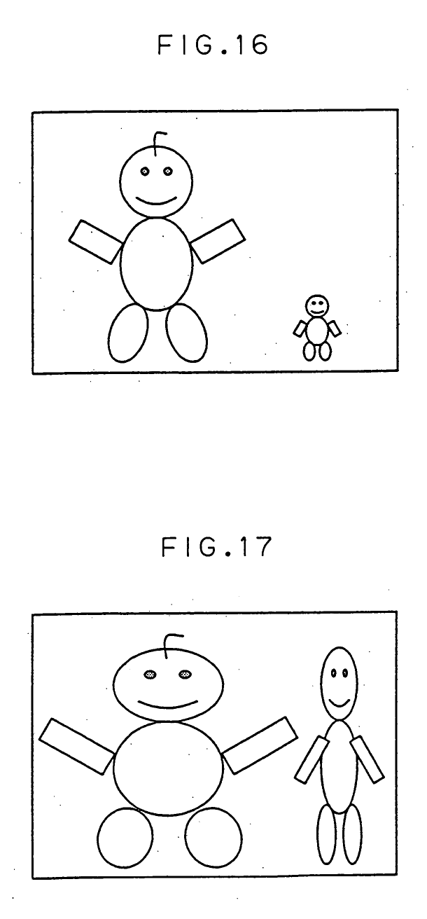

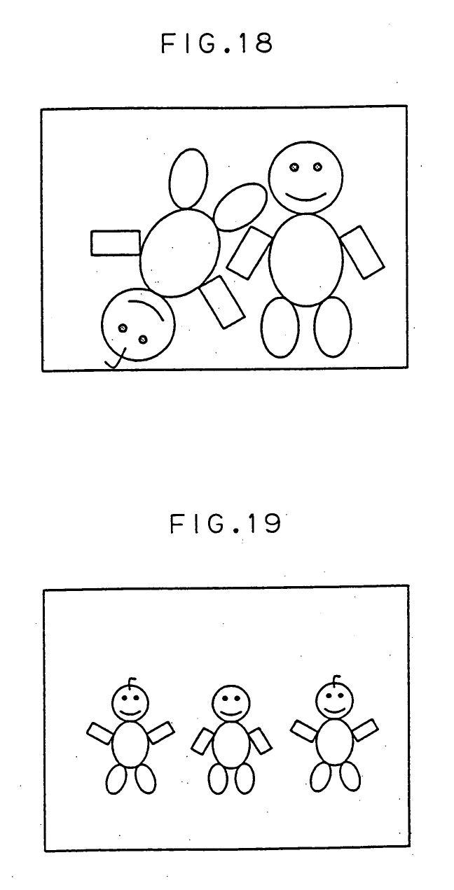

As a third method of achieving the synchronization, a sample of a composite image is exhibited, and the information-provision graphic may be limited so that a composite image like the sample is formed. For example, a sample of a composite image of a large person and a small person as shown in FIG. 16 is exhibited, and in order that such composition is performed, the information-provision graphic at the user side is limited to FIG. 7, and the information-provision graphic at the partner side is limited to FIG. 14. As a sample of another composite image, a sample of a composite image of a fat person and a thin person as shown in FIG. 17, a sample of a composite image of a rotated person and a not-rotated person as shown in FIG. 18, a sample of a composite image of a person with a duplicate and a person without a duplicate as shown in FIG. 19, or the like may be exhibited.

By this modification, the adjustment of the photograph conditions for various compositions becomes easy.

### (14) Modified Example 14

In the first embodiment, although the photographed image 202 and the input image 205 are not objected to an image processing in the image-combining apparatus 212 of FIG. 2, they may be objected thereto.

For example, the image processing such as enlargement, reduction, or rotation may be performed. By this modification, various composite images are formed.

### (15) Modified Example 15

In the first embodiment, the photographed image and the information-provision graphic are combined with each other at S1030 in the flow of the processing of FIG. 1, and the composite image is displayed at S1040. However, by the user instruction, not the image in which the information-provision graphic is combined, but the photographed image may be displayed.

By this modification, since the photographed image not combined is confirmed, the photograph conditions can be more easily adjusted.

### (16) Modified Example 16

In the first embodiment, in the image-combining apparatus 212 of FIG. 2, the area of the object is extracted from the photographed image 202, is superimposed on the input image 205 and is combined therewith. However, an image processing to shade the area of the extracted object may be performed.

By this modification, the composite image which can be seen without an uncomfortable feeling is formed.

### (17) Modified Example 17

In the first embodiment, in the image-combining apparatus 212 of FIG. 2, the area of the object is extracted from the photographed image 202, is superimposed on the input image 205 and is combined therewith. However, the area of the object may be extracted from the input image 205 and may be superimposed on the photographed image 202 to be combined therewith.

For that purpose, in the input image composition unit 304 of FIG. 4, the photographed image 202 and the input image 205 have only to be reversed. Then, a composite image different from the first embodiment is formed.

### (18) Modified Example 18

In the first embodiment, although the storing of the photographed image 202 in the reference image storage unit 401 is based on the adjustment end instruction 209, a unit which instructs the storing may be provided. Then, it becomes possible for the user to cause the storing at any time.

### (19) Modified Example 19

In the first embodiment, although the information-provision graphic 207 is combined with the photographed image 202, FIG. 3 is modified, and the information-provision graphic 207 may be combined with an image in which the photographed image 202 and the input image 205 are combined with each other.

By this modification, information can be provided also in the world of the composite image.

### (20) Modified Example 20

In the first embodiment, although the image to be displayed is determined through the adjustment end instruction 209, the photographed image 202 and the input image 205 may be displayed at any time when another user instruction is issued. Then, the difference between the world of the composite image and the actual world becomes easy to confirm.

### Second Embodiment

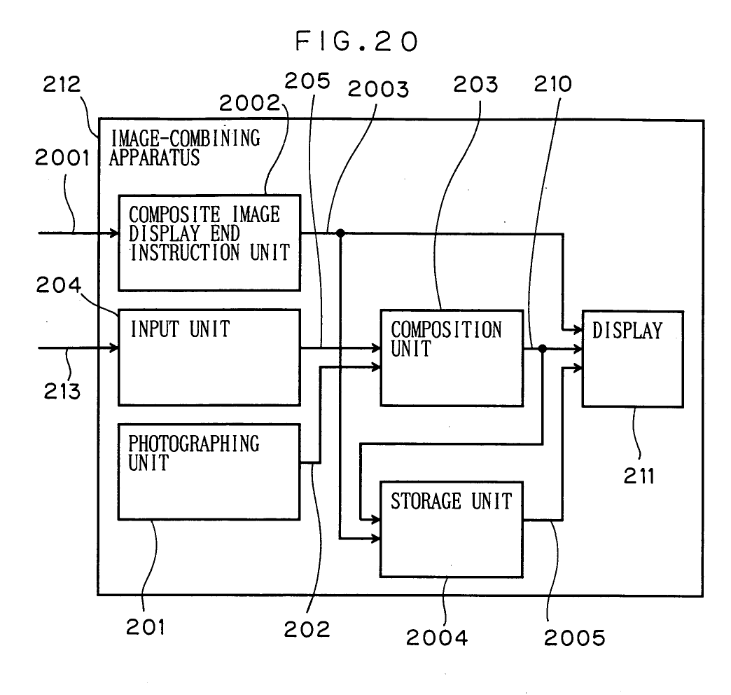

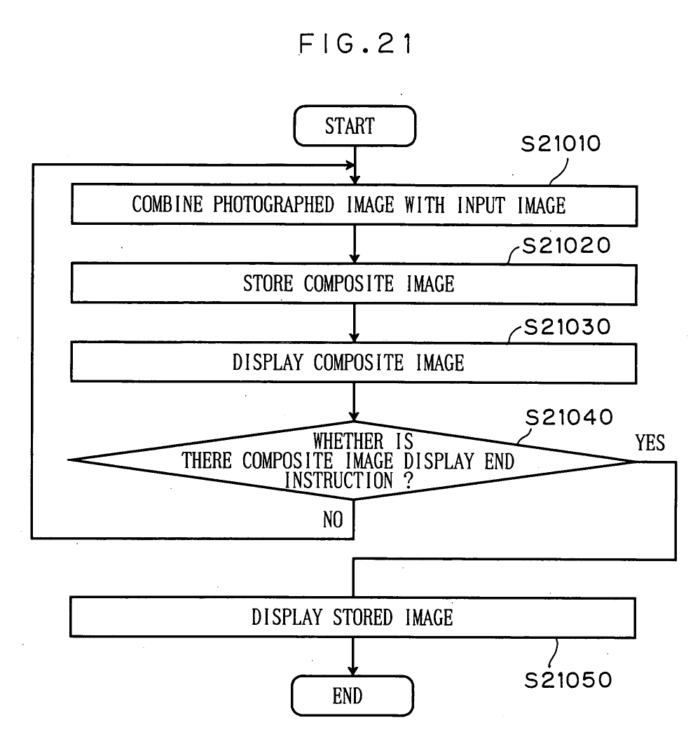

A second embodiment of the invention in which a composite image is stored and the stored image is displayed after the display of the composite image is stopped, will be described with reference to FIGS. 20 and 21.

(1) Structure of Image-Combining Apparatus 212

FIG. 20 is an explanatory view showing a schematic structure of an image-combining apparatus 212 according to this embodiment. A portion different from FIG. 2 will be described.

The user operates a composite image display end instruction unit 2002 so that a composite image display end operation 2001 is performed. In the composite image display instruction unit 2002, until just before the composite image display end operation 2001 is performed, an instruction not to end the display of a composite image is sent as a composite image display end instruction 2003 to a storage unit 2004 and a display 211. Immediately after the composite image display end operation 2001 is performed, an instruction to end the display of the composite image is sent as the composite image display end instruction 2003 to the storage unit 2004 and the display 211.

In a composition unit 203, a composite image formed in the same way as that in the description of the structure and the connection example of the first embodiment is sent as a composite image 210 to the display 211 and the storage unit 2004. In the storage unit 2004, in the case where the composite image display end instruction 2003 is the instruction not to end the display of the composite image, the composite image 210 is stored, whereas in the case of the instruction to end the display of the composite image, the stored image is switched at specified time intervals, and is sent as a stored image 2005 to the display 211.

In the display 211, in the case where the composite image display end instruction 2003 is the instruction not to end the display of the composite image, the composite image 210 is displayed, whereas in the case of the instruction to end the display of the composite image, the stored image 2005 is displayed. Incidentally, the composite image display end instruction unit 2002 is, for example, an exclusive switch, and the storage unit 2004 is, for example, a RAM or an HDD.

(2) Processing Procedure of Image-Combining Apparatus 212

FIG. 21 is a flowchart showing a flow of a processing of the image-combining apparatus 212 in this embodiment. The description will be made in connection with the structure of the image-combining apparatus 212 of FIG. 20.

First, at S21010, the composite image 210 of a photographed image 202 and an input image 205 is formed.

Next, at S21020, the composite image 210 is stored in the storage unit 2004.

Next, at S21030, the composite image 210 is displayed on the display 211.

Next, at S21040, a conditional branch occurs by the composite image display end instruction 2003. In the case where the composite image display end instruction 2003 does not instruct the end of the display of the composite image 210, the procedure returns to S21010. In the case where the end is instructed, the procedure proceeds to S21050.

Finally, at S21050, the stored image 2004 stored at S21020 is displayed on the display 211 at specified time intervals.

(3) Effects of the Second Embodiment

According to the second embodiment, the photographed image 202 or a specific image is not displayed after the display of the composite image 210 is ended, but the stored image 2005 as the stored composite image 210 is displayed, and accordingly, the user is prevented from immediately feeling emptiness.

### MODIFIED EXAMPLES OF THE SECOND EMBODIMENT

Hereinafter, modified examples of the second embodiment will be described.

### (1) Modified Example 1

In the second embodiment, although the stored image 2005 is not subjected to an image processing and is displayed, it may be subjected thereto.

For example, one or more stored images 2005 are rotated, enlarged or reduced, and images which appear to be pasted on a book may be displayed.

Besides, an image processing may be performed to achieve a sepia tone.

Besides, at the time when the composite image 210 is switched to the display of the stored image 2005, or at the time when the display is switched between the stored images 2005, an image effect may be used. As the image effect, cut connection, fade-out, overlap, wipe, slide-out or the like may be used.

By this modification, the stored image 2005 is effectively exhibited.

### (2) Modified Example 2

In the second embodiment, although the stored image 2005 is displayed after the composite image display end instruction 2003, it may be displayed at a time other than that.

At that time, the date and time may be displayed on the stored image 2005 at the same time. The date and time, together with the composite image 210, may be stored when the composite image 210 is stored in the storage unit 2004.

Besides, a comment may be displayed. It is appropriate that the comment is stored in accordance with user instructions.

Further, the stored image 2005 may be printed.

By this modification, the user can watch the stored image 2005 at any time.

### (3) Modified Example 3

In the second embodiment, although the composite image 210 is stored in the storage unit 2004 at S21020, it may be stored according to user instructions.

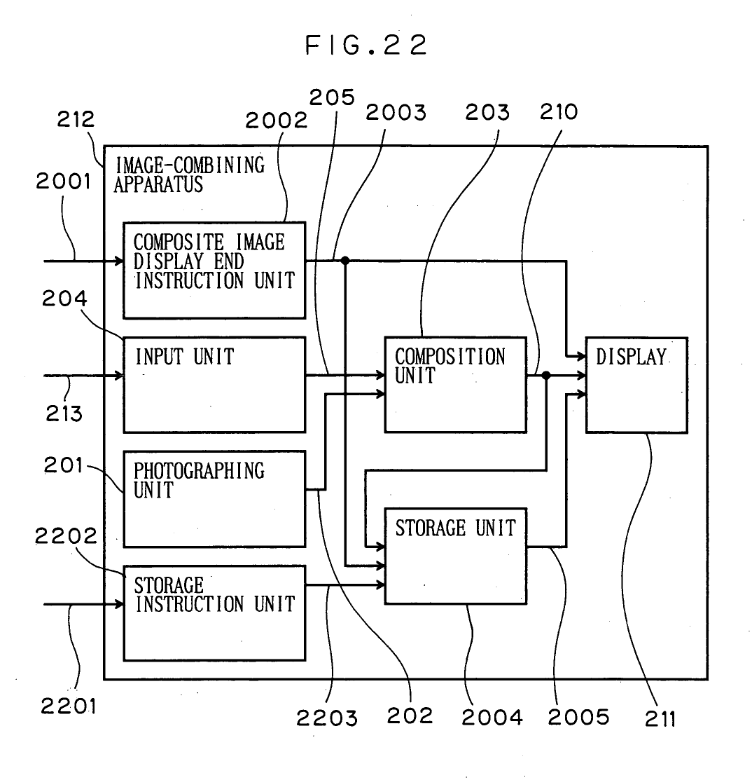

For that purpose, for example, as shown in FIG. 22, it is appropriate that a storage instruction unit 2202 is added.

When the user performs the storage instruction operation 2201 to issue an instruction to store the composite image 210, in the storage instruction unit 2202, the storage instruction 2203 to store the composite image 210 is sent to the storage unit 2004, and in the storage unit 2004, only when the storage instruction 2203 is received, the composite image 210 is stored. Incidentally, the storage instruction unit 2202 is, for example, a button or a button of a remote control.

By this modification, the composite image 210 desired by the user is stored as the stored image 2005, and the stored image 2005 is effectively exhibited.

### (4) Modified Example 4

In the second embodiment, although the composite image 210 is stored in the storage unit 2004 at S21020, it may be stored at specified time intervals. Then, the composite images 210 separated at intervals of time are stored as the stored image 2005, and the stored image 2005 is effectively exhibited.

### (5) Modified Example 5

In the second embodiment, although the composite image 210 is stored in the storage unit 2004 at S21020, it may be stored at the time when a feature quantity indicating a change of an image is changed more than a specified value.

For example, in each of elements of the composite image 210, a difference in a pixel value between frames is calculated, and the composite image may be stored when the sum of the differences concerning all pixels is larger than a specified value.

The calculation of the differences between the frames may be performed with respect to the photographed image 202 or the input image 205, not the composite image 210. However, in that case, a connection must be performed so that the photographed image 202 or the input image 205 is sent to the storage unit 2004. Then, the composite image 205 at the time when a change occurs in the image in which the differences are calculated, is stored as the stored image 2005, and the stored image 2005 is effectively exhibited.

### Third Embodiment

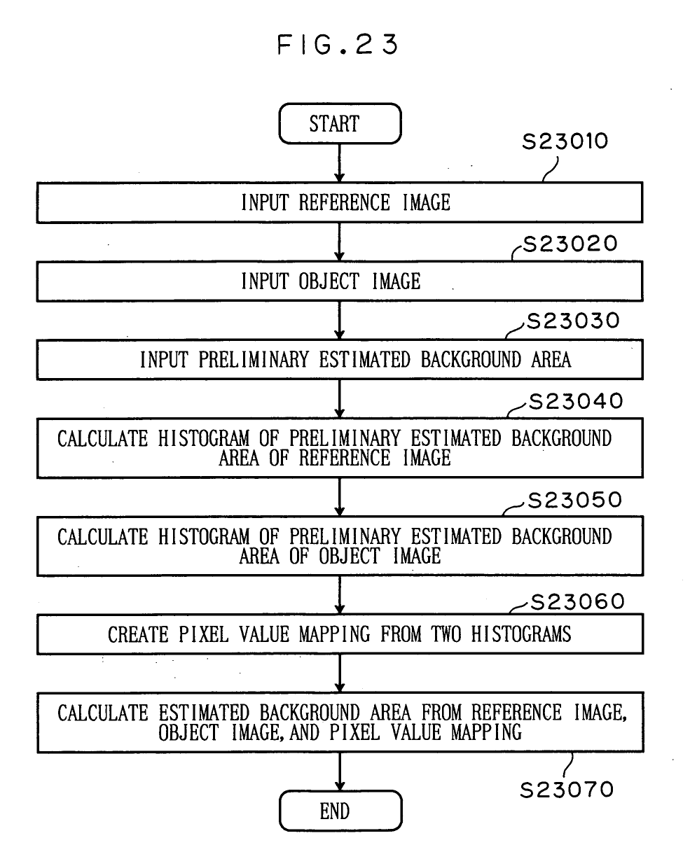

A third embodiment of the invention in which a reference image is converted in accordance with a pixel value of a target image will be described with reference to FIGS. 23 to 28.

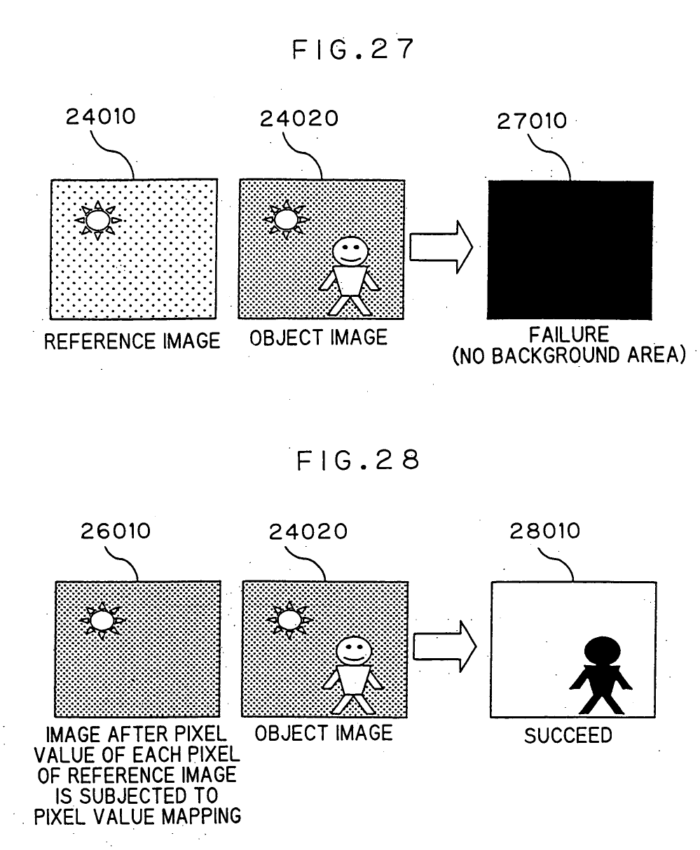

What is intended in this embodiment is as follows. When the reference image in which only the background is photographed is compared with the target image in which the object exists in the background image, and only the background area is cut out of the target image, since the pixel values (for example, density values) of the reference image and the target image are different, when the comparison is simply made and the background area is cut out, it ends in failure as shown in FIG. 27. Then, after the pixel values of respective pixels of the reference area are fitted to the pixel values of the background area of the target image, the fitted reference image and the target image are compared with each other, and the background area is cut out as shown in FIG. 28.

Incidentally, when this embodiment is used for the creation of the estimated object area 404 described in the first embodiment, the estimated object area 404 is estimated with high accuracy.

(1) Processing Procedure

FIG. 23 is a flowchart showing a flow of a processing in this embodiment.

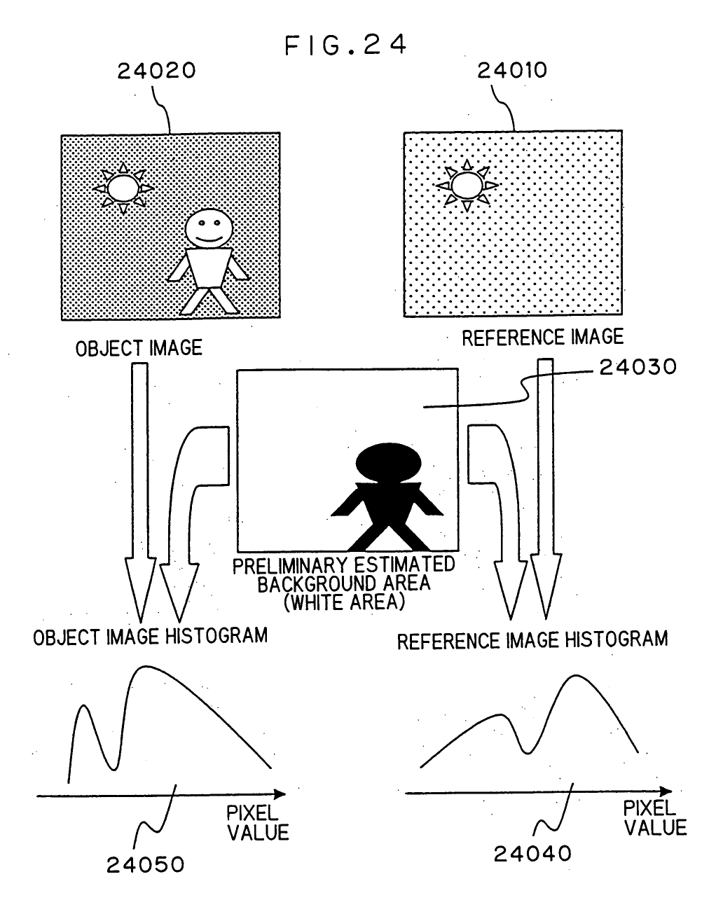

At S23010, a reference image is inputted. The reference image is, for example, an image 24010 of FIG. 24. That is, it is the image in which only the background area is photographed.

At S23020, a target image is inputted. The target image is, for example, an image 24020 of FIG. 24. That is, it is the image in which a person as an object is photographed in the same background area as the reference image. However, in the case where the target image and the reference image are compared with each other, although the contents (for example, a building and a tree) photographed in the background of the object are the same, the pixel values (for example, density values) are different from each other according to solar radiation, weather, and time.

At S23030, a preliminary estimated background area as a set of pixels in the image is inputted. As the preliminary estimated background area, for example, a white area 24030 of FIG. 24 is manually specified and is inputted. That is, a portion of the target image other than the object becomes the preliminary estimated background area. Here, the object of this processing is to obtain the background area of the target image other than the object, and although it appears to be the same process as the process of obtaining the preliminary estimated background area, the entities are different. The process of this step is for previously determining the initial value for obtaining the background area other than the object, and differently from the background area of the final object, in the preliminary estimated background area, it is not necessary to accurately specify the area other than the object.

At S23040, a reference image histogram is calculated which indicates appearance frequencies of pixel values of pixels included in the preliminary estimated background area of the reference image. The calculated reference image histogram is, for example, a histogram 24040 of FIG. 24. The horizontal axis of this histogram indicates the pixel value (for example, density value), and the vertical axis indicates the frequency. That is, this histogram indicates the number of pixels at each of the pixel values.

At S23050, a target image histogram is calculated which indicates appearance frequencies of pixel values of pixels included in the preliminary estimated background area of the target image. The calculated target image histogram is, for example, a histogram 24050 of FIG. 24. In this histogram, the horizontal axis indicates the pixel value (for example, density value), the vertical axis indicates the frequency, and for example, the number of pixels at each density value is indicated.

At S23060, such mapping that a cumulative frequency of density values after density values of the respective pixels included in the preliminary estimated background area of the reference image are subjected to the mapping approaches a cumulative frequency of density values of the target image is calculated as a pixel value mapping. Incidentally, the description will be made while the density value is used as the pixel value.

For example, the pixel value mapping is calculated by following processes of (1-1) to (1-6).

(1-1) A minimum density value at which the frequency of the density value of the reference image histogram is not 0 is searched for. The density value is made u.

(1-2) A minimum density value at which the frequency of the density value of the target image histogram is not 0 is searched for. The density value is made v.

(1-3) One is subtracted from the frequency of the density value u of the reference image histogram and from the frequency of the density value v of the target image histogram, and v is stored.

(1-4) If the frequency of the density value u of the reference image histogram is not 0, the procedure proceeds to (1-5). In the other case, a typical value of the density value stored in (1-3) is obtained, it is made a transformation destination of the density value u, a next density value at which the frequency of the reference image histogram is not 0 is searched for, the density value is made v, and the procedure returns to (1-3). Here, in the case where the next density value at which the frequency of the reference image histogram is not 0 does not exist, the procedure proceeds to (1-6).

(1-5) If the frequency of the density value v of the target image histogram is not 0, the procedure returns to (1-3). In the other case, a next density value at which the frequency of the target image histogram is not 0 is searched for, the value is made v, and the procedure returns to (1-3).

(1-6) The transformation from a density value whose conversion destination is not determined is interpolated, and the processing is ended.

A calculation method of the pixel value mapping other than the above processes of (1-1) to (1-6) may be adopted.

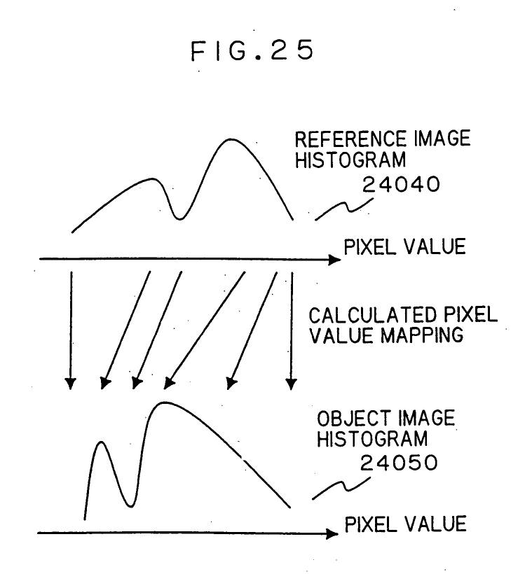

The calculated pixel value mapping is, for example, the mapping as shown in FIG. 25.

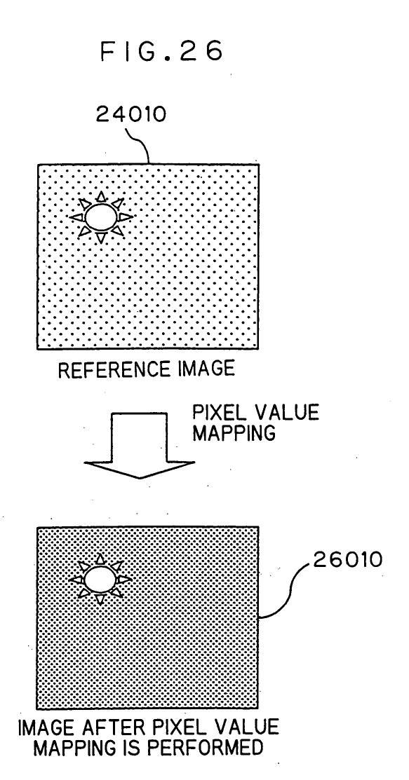

At S23070, pixels in which a difference in a pixel value of each pixel between the image in which the pixel values of the respective pixels of the reference image are subjected to the pixel value mapping calculated at S23060 and the target image is a previously determined threshold or lower, are calculated as the estimated background area. For example, when the pixel values of the respective pixels of the reference image 24010 are subjected to the pixel value mapping of FIG. 25, an image 26010 of FIG. 26 is created. The pixel values of the image 26010 are close to the pixel values of the area of the target image 24020 other than the person.

A set of pixels in which the difference in the pixel value of each pixel between the image 26010 and the target image 24020 is the previously determined threshold or lower is calculated as the estimated background area.

Incidentally, at S23070, when a fourth embodiment described later is applied, the estimated object area 404 is estimated with high accuracy.

(2) Processing Procedure in the Case Where the Third Embodiment is Applied to Creation of the Estimated Object Area 404 in the First Embodiment

The description will be given to the processing procedure in the case where this embodiment is applied to the creation of the estimated object area 404 described in the first embodiment.

Incidentally, the description will be given while it is assumed that the extraction unit 403 includes an area storage unit as a unit which stores an area as a set of pixels, and the estimated object area 404 sent from the extraction unit 403 immediately before the new photographed image 202 is sent to the extraction unit 403 is stored as a storage object area in the area storage unit.

Besides, it is assumed that when the photographed image 202 is first sent to the extraction unit 403, the area expressing the set of all pixels of the image is stored as the storage object area.

At S23010, an average image of the reference image 402 is inputted as the reference image.

At S23020, the photographed image 202 is inputted as the target image.

At S23030, a complementary set of the storage object area stored in the extraction unit 403 is inputted as the preliminary estimated background area.

At S23040, S23050 and S23060, the processing is performed as described above.

At S23070, as described above, the estimated background area is calculated, and a complementary set of the estimated background area is created as the estimated object area 404.

(3) Effects of the Third Embodiment

If the processes of S23030, S23040, S23050 and S23060 are omitted, and only the processes of S23010, S23020 and S23070 are performed, for example, a white area (not existing) of S27010 of FIG. 27 is estimated as the estimated background area, and the estimation ends in failure.

On the other hand, when all the processes of this embodiment are performed, a white area 28010 of FIG. 28 is estimated as the estimated background area, and the estimation succeeds.

According to this embodiment, even in the case where the pixel values of the pixels are changed nonlinearly by an illumination change or a correction of a camera, the background area is estimated with high accuracy. That is, the area of the object as the complementary set of the background area is extracted with high accuracy.

### MODIFIED EXAMPLES OF THE THIRD EMBODIMENT

Hereinafter, modified examples of the third embodiment will be described.

### (1) Modified Example 1

In the third embodiment, although the area specified manually is inputted as the preliminary estimated background area, it is not always necessary to do so.

In the case where the background area is sequentially estimated from the respective frame images of a moving image, similarly to the input method of the preliminary estimated background area described in the processing procedure in the case where the third embodiment is applied to the creation of the estimated object area 404 in the first embodiment, the estimated background area calculated immediately before may be inputted as the preliminary estimated background area.

As a countermeasure to a case where a small area is erroneously mixed in the estimated background area, an expansion process is performed to the estimated background area calculated immediately before, and an area in which the small area is removed may be inputted as the preliminary estimated background area.

However, in the case where the first frame of the moving image is processed, the area as a set of all pixels of the image is made to be inputted as the initial estimated image.

By this modification, the trouble to manually input the preliminary estimated background area can be saved.

### (2) Modified Example 2

According to the third embodiment, at S23060, although such mapping that the cumulative frequency of the pixel values after the pixel values of the respective pixels included in the preliminary estimated background area of the reference image are subjected to the mapping approaches the cumulative frequency of the pixel values of the target image is calculated as the pixel value mapping, it is not always necessary to do so.

Such mapping that a cumulative frequency of pixel values after the pixel values of the respective pixels included in the preliminary estimated background area of the target image is subjected to the mapping approaches a cumulative frequency of pixel values of the reference image may be calculated as the pixel value mapping.

In the case where such modification is performed, at S23070, further modification may be performed so that pixels in which a difference in a pixel value of each pixel between the image in which the pixel values of the respective pixels of the target image are subjected to the pixel value mapping and the reference image is a specified threshold or lower are calculated as the estimated background area. By this modification, either of the reference image and the target image may be subjected to the pixel value mapping.

### (3) Modified Example 3

In the third embodiment, at S23070, although the background difference method is used in which the set of pixels in which the difference in the pixel value of each pixel is the specified threshold or lower is estimated as the estimated background area, the estimated background area may be estimated by using another background difference method.

For example, a fourth embodiment descried later may be used. By this modification, the background area is estimated with high accuracy.

### Fourth Embodiment

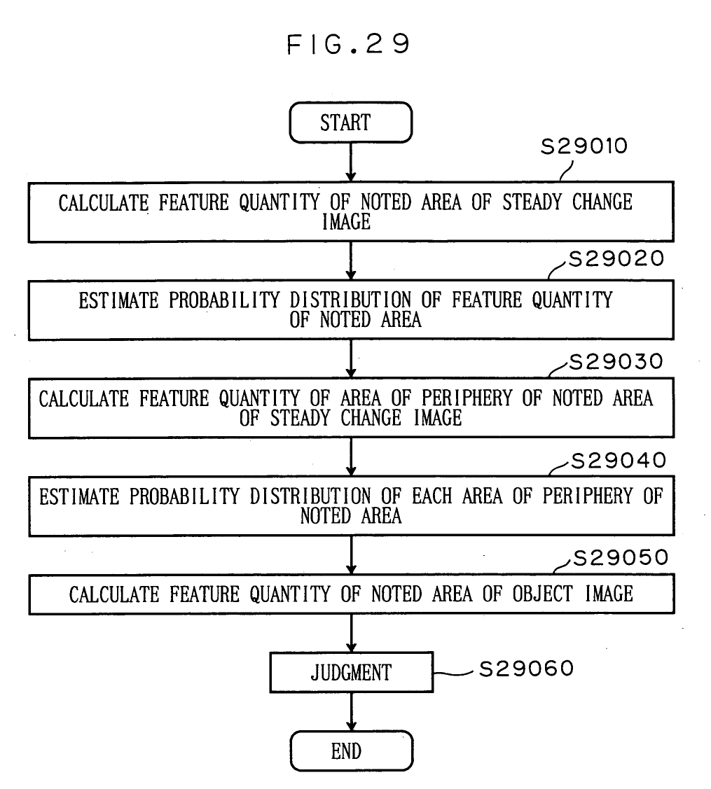

The fourth embodiment in which it is judged whether or not an unsteady change occurs in a noted pixel of a target image will be described by use of FIGS. 29 to 38.

This embodiment is a technique in which the technique of patent document 1 is improved so that even if a steady change image as a time series of images in a steady change state exists only for a short time, the existence of an unsteady change can be judged with high accuracy.

The “steady change state” means a state in which leaves are periodically swayed, the water surface sways, or all things in the image are swayed by hands movement. Here, the description will be given while it is assumed that a pixel value is not a vector but a scalar. Incidentally, the pixel value is the lower conception of the feature quantity, and the “feature quantity” will be described in modified example 1 described later.

Incidentally, for the purpose of creating the estimated object area 404 described in the first embodiment, this embodiment can be used. Besides, the third embodiment is used for the creation of the estimated object area 404 described in the first embodiment, and this embodiment may be used at S23070.

(1) Processing Procedure

FIG. 29 is a flowchart showing a flow of a processing in this embodiment.

First, there are prepared a time series of steady change images in which a steady change is photographed and a target image as a comparison object. Incidentally, this steady change image is the reference image in the third embodiment, and it is necessary that the same range be photographed in the steady change image and the target image. Processes of the steady change image are indicated in steps from S29010 to S29040.

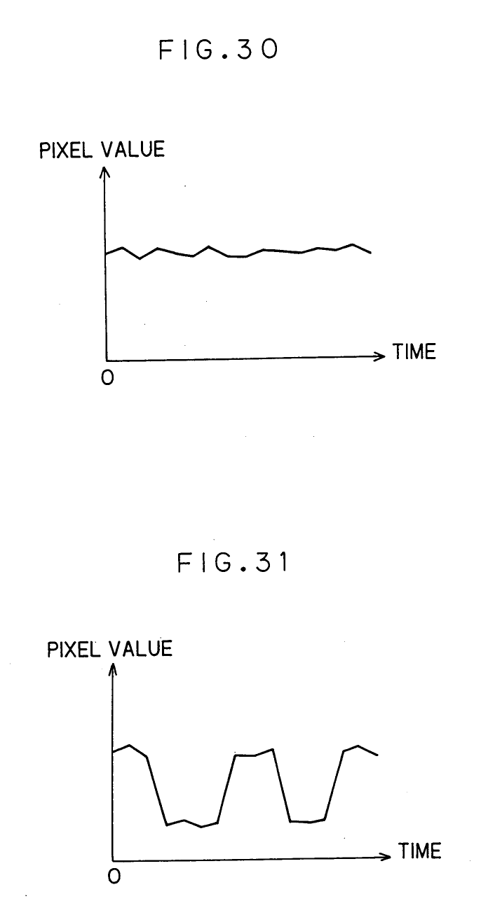

At S29010, a time series of pixel values of a corresponding noted pixel corresponding to a noted area of the target image in the steady change image is calculated. For example, when leaves are swayed, the leaves and things existing behind them are alternately photographed in the corresponding noted pixel. FIG. 30 is an explanatory view showing an example of a time series of pixel values in a pixel in which a steady change does not occur and which is in a still state. FIG. 31 is an explanatory view showing an example of a time series of pixel values in a pixel in which a steady change occurs and which is not in a still state.

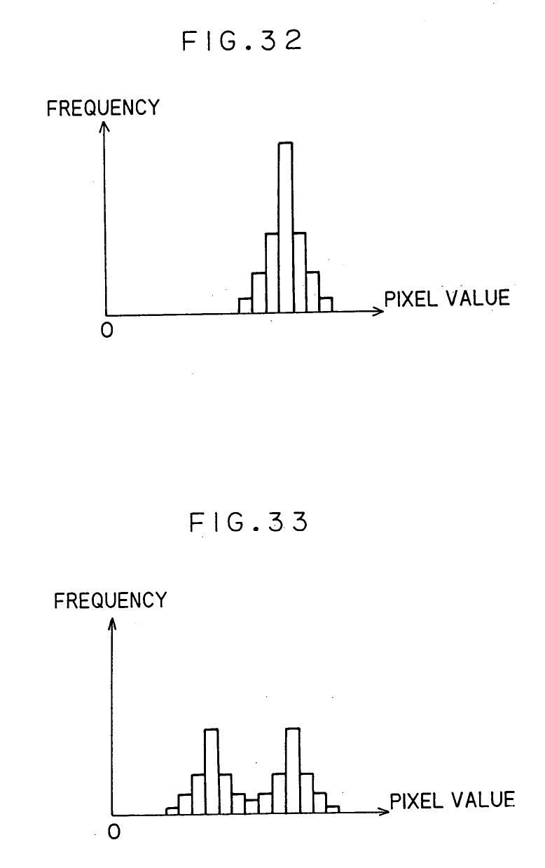

At S29020, a histogram relating to the pixel values is created from the time series of pixel values of the corresponding noted pixel obtained at S29010, and an occurrence probability distribution is created by dividing the frequency of each pixel value by the sum of frequencies of all the pixel values. FIG. 32 is an explanatory view showing an example of an occurrence probability distribution created from a time series of pixel values in a pixel in which a steady change does not occur and which is in a still state. FIG. 33 is an explanatory view showing an example of an occurrence probability distribution created from a time series of pixel values in a pixel in which a steady change occurs and which is not in a still state.

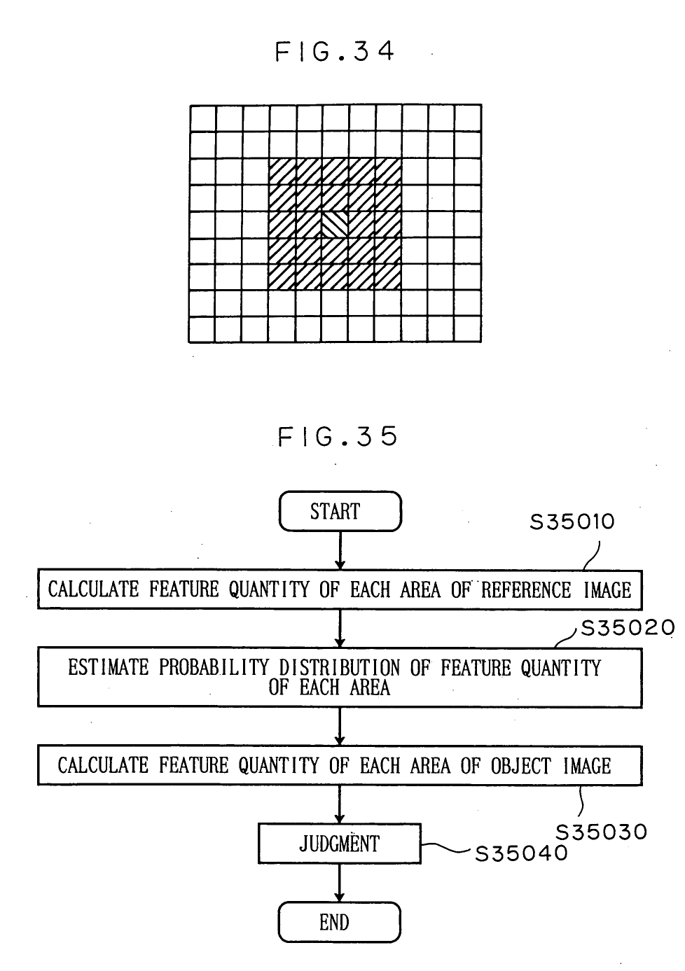

At S29030, a time series of pixel values of the steady change image is calculated at each of peripheral pixels of the corresponding noted pixel. FIG. 34 is an explanatory view showing an example of the peripheral pixels of the corresponding noted pixel. When the pixel of a downward-sloping oblique line portion is the corresponding noted pixel, the peripheral pixels of the corresponding noted pixel are pixels of upward-sloping oblique line portions. It is not necessary that the size and shape of the set of the peripheral pixels are the same as those of FIG. 34, but are set correspondingly to the steady change appearing in the target image.

At S29040, in each of the peripheral pixels of the corresponding noted pixel, first, the occurrence probability distribution is created from the time series of pixel values obtained at S29030 similarly to S29020.

At S29050, a pixel value f(x, y) of a noted pixel (x, y) of the target image is calculated.

At S29060, it is judged by using mathematical expression 1 whether or not an unsteady change is occurring in the noted pixel (x, y) of the target image.

A set of peripheral pixels of the noted pixel (x, y) is made R(x, y), and a previously determined specified probability value is made T. Besides, it is assumed that a value of the occurrence probability distribution created at S29020 and s29040 with respect to the pixel value v is expressed by P_{(x′, y′)}(v).

When
^{∀}(x′,y′)εR(x,y)(P_{(x′,y′)}(f(x,y))<T) [mathematical expression 1]
is satisfied, it is judged that the unsteady change has occurred in the noted pixel (x, y), and when not satisfied, it is judged that the unsteady change has not occurred.
(2) Processing Procedure in the Case Where the Fourth Embodiment is Applied to the Creation of the Estimated Object Area 404 in the First Embodiment

The description will be given to the processing procedure in the case where this embodiment is applied to the creation of the estimated object area 404 described in the first embodiment.

Incidentally, this embodiment may be applied after the third embodiment is applied. FIG. 35 is a flowchart showing the processing procedure.

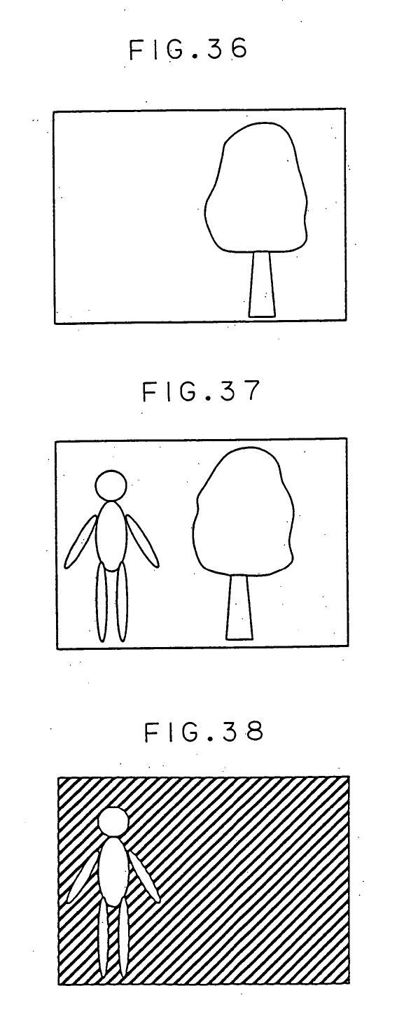

At S35010, time series of pixel values in all pixels are calculated. A reference image 402 is an image in which the object is not photographed. In the scene of the reference image 402, for example, sway occurs by hands movement, or leaves are swayed. A frame image with the reference image 402 is, for example, an image of FIG. 36.

At S35020, with respect to each of the pixels, the occurrence probability distribution is created from the time series of pixel values of the pixel calculated at S35010.

At S35030, pixel values in all the pixels are calculated from the photographed image 202. Incidentally, with respect to the photographed image 202, the photographing unit 201 has not been moved since the image of FIG. 36 was photographed and the object is photographed. However, when the degree of movement is such that the photographing unit 201 is moved by hands movement, it may be moved. The photographed image 202 is, for example, an image of FIG. 37. FIG. 37 is shifted from FIG. 36 by hands movement, and the positions of the leaves are shifted by the sway of the leaves.

At S35040, each pixel is made the noted pixel, and when mathematical expression 1 is satisfied, it is judged that the noted pixel is a part of the object area, and in the other case, it is judged that the pixel is not a part of the object area. Then, for example, an oblique line portion of FIG. 38 is judged to be the area which is not the object, the remaining area is judged to be the object area, and the estimated object area 404 is created.

(3) Effects of the Fourth Embodiment

According to this embodiment, even if the steady change image exists only for a short time, the unsteady change in the noted pixel can be detected with high accuracy.

Incidentally, the time series of images in which the object is not photographed is made the steady change image, the image in which the object is photographed is made the target image, and when this embodiment is applied to the extraction of the object in the first embodiment, even if leaves are swayed behind the object, the water surface sways, or all things in the image are swayed by hands movement, the area of the object is extracted with high accuracy from the image which exists for a short time and in which the object is not photographed.

### MODIFIED EXAMPLES OF THE FOURTH EMBODIMENT

Hereinafter, modified examples of the fourth embodiment will be described.

### (1) Modified Example 1

In the fourth embodiment, although the description has been given to the case where the pixel value is used as the feature quantity and the pixel value is the scalar, it may be a vector.

Besides, as the feature quantity, a value or a vector having, as elements, results in which pixel values are subjected to an operation may be used. As the operation, there are spatial differential, temporal differential, spatial integral, temporal integral and the like.

In the case where the feature quantity is an n-dimensional vector, and each element has M gradations, it is necessary to ensure a storage area for storing the frequency of each of M^{N} kinds of feature quantities for creation of a histogram of a pixel. When M^{N} is a large number, a large storage area must be ensured. In order to reduce the storage area, it is appropriate that the histogram relating to each element of the feature quantity is created at the time of the creation of the histogram, the occurrence probability distribution relating to each element is created, the occurrence probability distribution is used and the existence of the unsteady change is judged from
^{∀}(x′y′)εR(x,y)(³n<N(P_{(x′,y′),n}(fₙ(x,y))<T)) [mathematical expression 2]

Here, fₙ(x′, y′) denotes nth (n=0, 1, . . . N−1) element of the feature quantity of a pixel (x′, y′), and P_{(x′, y′)},n(vₙ) denotes a value, with respect to an element value vₙ, of the occurrence probability distribution created from the time series of the nth element of the feature quantity of the pixel (x′, y′).

Besides, there is also a following method to reduce the storage area. In the case where the feature quantity is a high-order (N is large) vector, since the number of elements whose frequencies become zero is apt to become large, when a list of a pair (histogram element) of {vector, frequency} which is not zero is stored, the storage area can be reduced in many cases. However, when the list is simply used, the speed is significantly lowered. Then, for example, a function (hash function) by which a vector of a feature quantity is projected to a scalar (hash value) such as an integer of 0 to 1023 is defined, and when the list of histogram elements is stored for each hash value, the speed reduction due to the use of the method of storing the list can be made small.

By this modification, the unsteady change in the noted pixel can be detected with higher accuracy. Besides, in the case where the feature quantity is the vector, the storage area for histogram creation can be reduced.

### (2) Modified Example 2

In the fourth embodiment, although the processing is made on basis of a pixel, the processing may be made on basis of an area.

Then, the unsteady change in the noted area, not the noted pixel, is judged. The feature quantity is not the pixel value, and a vector in which pixel values of pixels in the area are arranged may be used. When the processing is on basis of an area, the processing speed is improved.

### (3) Modified Example 3

In the fourth embodiment, since the occurrence probability distribution is created by the appearance frequency of the pixel value in the steady change image, in the case where the steady change image exists for an extremely short time such as in the case where the steady change image is only one frame, there is a case in which whether or not the unsteady change exists can not be judged with high accuracy.

A flow of a processing of a modified example in which a judgment can be made with high accuracy also in such a case, will be described by use of FIG. 29. In this case, a target image, a time series of steady change images, and a still state image are prepared. The target image is the image in which it is judged whether or not the steady change occurs in the noted area similarly to the above. In the time series of steady change images, it is not necessary that the same range is photographed in the target image, and it is necessary that the steady change state be photographed in the time series. In the still state image, the same range is photographed in the target image.

At S29010, first, the time series of the pixel values of the noted pixel as the pixel in the steady change state is calculated from the steady change image. Next, the time series of the pixel values of the corresponding noted pixel corresponding to the noted pixel of the target image is calculated from the still state image.

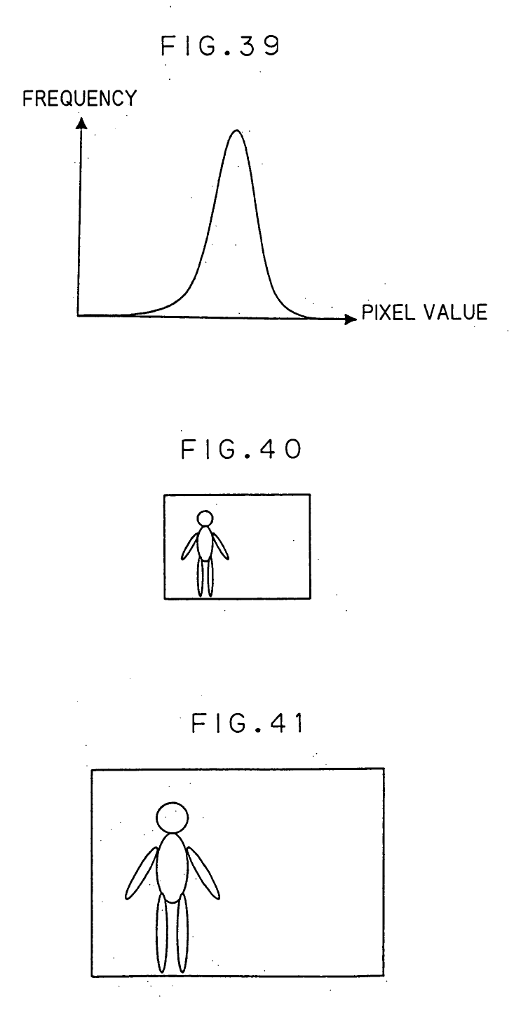

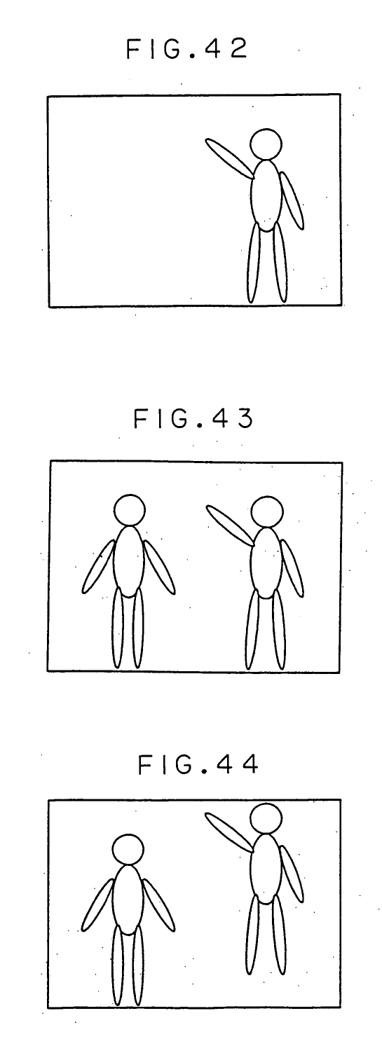

At S29020, first, a typical value is calculated from the time series of the pixel values of the steady change image calculated at S29010. As the typical value, it is appropriate that the most frequent value is used. The center value or average value may be used. Next, variance or unbiased variance is calculated from the time series of the pixel values of the still state image calculated at S29010. Next, a normal distribution is created which has the typical value as an average and the variance or unbiased variance as variance. FIG. 39 is an explanatory view showing the normal distribution. The curved line expresses the normal distribution.

At S29030, in each of the peripheral pixels of the noted pixel, first, the time series of the pixel values of the steady change image is calculated. Next, the time series of the pixel value of the still state image is calculated.

At S29040, in each of the peripheral pixels of the corresponding noted pixel, first, a typical value is calculated from the time series of the pixel values of the steady change image obtained at S29030. Next, variance or unbiased variance is calculated from the time series of the pixel values of the still state image obtained at S29030. Next, at each of the peripheral pixels of the noted pixel, the normal distribution is created which has the typical value as the average and the variance or unbiased variance as variance. At S29050, the processing is performed similarly to the processing of the fourth embodiment.

At S29060, in the case where a value, with respect to a pixel value v, of the normal distribution of the pixel (x′, y′) created at S2920 and S29040 is expressed by F_{(x′,y′)}(v), when
^{∀}(x′,y′)εR(x,y)(F_{x′,y′)}(f(x,y))<T) [mathematical expression 3]
is satisfied, it is judged that the unsteady change has occurred in the noted pixel, and when not satisfied, it is judged that the unsteady change has not occurred.

By this deformation, also in the case where the time of the steady change image is extremely short, the existence of the unsteady change can be judged with high accuracy.

### (4) Modified Example 4

In the fourth embodiment, although the image is processed without being reduced, it may be processed after being reduced.

Incidentally, the reduction means an image processing of converting, for example, an image of FIG. 41 into an image of FIG. 40. By this modification, the processing speed becomes fast.

### (5) Modified Example 5

In the fourth embodiment, although the existence of the unsteady change in the noted pixel is judged according to mathematical expression 1, when

$${\sum }_{( {x}^{′} , {y}^{′} ) ∈ R ( x , y )} ( w ( {x}^{′} , {y}^{′} ) {P}_{( {x}^{′} , {y}^{′} )} ( f ( x , y ) ) ) < T \qquad [ mathematical expression 4 ]$$

is satisfied, it may be judged that the unsteady change has occurred, and when not satisfied, it may be judged that the unsteady change has not occurred. Where, w(x′, y′) is a weight satisfying

$${\sum }_{( {x}^{′} , {y}^{′} ) ∈ R ( x , y )} ( w ( {x}^{′} , {y}^{′} ) ) = 1 \qquad [ mathematical expression 5 ]$$

and can be set according to the steady change appearing in the target image.

By this modification, the existence of the unsteady change can be judged with higher accuracy.

### (6) Modified Example 6

In modified example 3 of the fourth embodiment, although the existence of the unsteady change in the noted pixel is judged according to mathematical expression 3, when

$${\sum }_{( {x}^{′} , {y}^{′} ) ∈ R ( x , y )} ( w ( {x}^{′} , {y}^{′} ) {F}_{( {x}^{′} , {y}^{′} )} ( f ( x , y ) ) ) < T \qquad [ mathematical expression 6 ]$$

is satisfied, it may be judged that the unsteady change has occurred, and when not satisfied, it may be judged that the unsteady change has not occurred.

Where, w(x′, y′) in mathematical expression 6 is a weight satisfying mathematical expression 5, and can be set according to the steady change appearing in the target image. By this modification, the existence of the unsteady change can be judged with higher accuracy.

### (7) Modified Example 7

In modified example 3 or modified example 6 of the fourth embodiment, although the different normal distributions are created in the respective pixels, a normal distribution having an average of variance or unbiased variance obtained in the respective pixels as variance may be created in the respective pixels.

Then, since the normal distributions different in average and common in variance are created in the respective pixels, the speed of calculation of mathematical expression 3 or mathematical expression 6 becomes high.

### (8) Modified Example 8

In the fourth embodiment, although the existence of the unsteady change is judged by mathematical expression 3; as in the JP-A-8(1996)-44874, the judgment may be made in view of the posterior probability.

By this modification, the existence of the unsteady change can be judged with higher accuracy.

### INDUSTRIAL APPLICABILITY

The present invention can be especially preferably applied to a communication system in which images photographed at plural points are combined with other.

1. A method of image processing, by which an own image showing a object is combined with an other image to form a composite image, comprising:
inputting said own image;
creating an information-provision graphic for determining a reference position to be used for combining the object on said own image with an area for the object on said other image;
positioning the object on said own image relative to a position of the information-provision graphic as the reference position; and
displaying an image after the positioning on a display.

2. A method of image processing according to claim 1, said information-provision graphic being a reference in respect of a size of the area or a posture of the area for the object for combining the object with the area.

3. A method of image processing according to claim 1, said positioning of the object comprising; adjusting a parameter in photography of the own image in accordance with a user's instruction.

4. A method of image processing according to claim 1, said creating of an information-provision graphic being made by acquiring the information-provision graphic from outside.

5. A method of image processing according to claim 1, said creating of an information-provision graphic being made in accordance with instructions given from outside.

6. A method of image processing, by which a plurality of images each showing respective objects are respectively combined with inputted images to form composite images, comprising:
storing the composite images in a memory; and
displaying on a display one or more of the composite images already stored in a memory in response of an instruction to stop displaying of a newly constructed one of the composite images.

7. A method of image processing according to claim 6, said storing being made sequentially at predetermined time intervals, or said storing being made if at least one of feature quantities respectively expressing variation of one of the composite image and respective ones of the inputted image exceeds a predetermined value.

8. A method of image processing, by which an estimated background area is calculated as a remnant other than an area of an object, from a photographed target image showing the object which entered in a background area, comprising:
inputting a reference image showing only the background area as well as the photographed target image;
designating a predetermined area as a preliminary estimated background area from the photographed target image;
calculating appearance frequencies of respective pixel values in respect of pixels included in an area on the reference image corresponding to the preliminary estimated background area, as to give a reference image histogram;
calculating appearance frequencies of respective pixel values in respect of pixels included in the preliminary estimated background area, as to give a target image histogram;
calculating a mapping from a set of pixel values in respect of the area on the reference image to a set of pixel values in respect of the preliminary estimated background area, by using the target image histogram and the reference image histogram; and
calculating the estimated background area by using the reference image, the photographed target image and the mapping.

9. A method of image processing according to claim 8, said mapping being made in a manner that the cumulative frequency of the pixel values in respect of either of the reference image and the target image approaches to that in respect of the other.

10. A method of image processing according to claim 8, the estimated background area being a set of pixels each having a difference not more than a separately determined threshold value, said difference being from a pixel value for a pixel on either of the reference image and the photographed target on either of the reference image and the photographed target image, to a value given by executing said mapping from a pixel value for a corresponding pixel on another of the reference image and the photographed target image.

11. A method of image processing, by which an image in steady variation state is used for determining whether there exists a non-steady deviation or not in a noted area of a target image, comprising:
calculating a first feature quantity on a first area corresponding to the noted area, on said image in steady variation state;
estimating a first occurrence probability distribution of the first feature quantity on said first area, from the first feature quantity;
calculating a second feature quantity on a second area surrounding said first area;
estimating a second occurrence probability distribution of the second feature quantity on said second area from the second feature quantity;
calculating a third feature quantity on the noted area of the target image; and
determining whether the unsteady deviation occurs or not in the noted area on basis of said third feature quantity and said first and second estimated occurrence probability distribution.

12. An image processing apparatus, for combining an own image showing a object with an other image to form a composite image, comprising:
an input unit for inputting the own image;
a processor unit which creates an information-provision graphic for determining a reference position to be used for combining the object on said own image with an area for the object on said other image;
a processor unit for positioning the object on said own image relative to a position of the information-provision graphic as the reference position; and
a display showing an image after the positioning.

13. A computer program for executing a method of image processing, by which an own image showing a object is combined with an other image to form a composite image, said program capable of realizing functions of:
inputting said own image;
creating an information-provision graphic for determining a reference position to be used for combining the object on said own image with an area for the object on said other image;
positioning the object on said own image relative to a position of the information-provision graphic as the reference position; and
displaying an image after the positioning on a display.
